(19) United States
(12) Patent Application Publication
(10) Pub. No.: US 2023/0036848 A1
(43) Pub. Date: Feb. 2, 2023

(54) AQUEOUS POLYMER ELECTROLYTE

(71) Applicant: Ligna Energy AB, Norrköping (SE)

(72) Inventors: Ziyauddin Khan, Norrköping (SE); Jakob Nilsson, Linköping (SE); Ujwala Ail, Linköping (SE); Nadia Ajjan, Norrköping (SE); Jaywant Phopase, Linköping (SE); Xavier Crispin, Kimstad (SE); Olle Inganäs, Inganäs (SE)

(73) Assignee: Ligna Energy AB, Norrköping (SE)

(21) Appl. No.: 17/758,643

(22) PCT Filed: Nov. 11, 2020
(86) PCT No.: PCT/EP2020/081757

§ 371 Date: Jul. 12, 2022

(30) Foreign Application Priority Data
Jan. 14, 2020 (EP) 20151663.0

(51) Int. Cl. H01M 10/0565

(52) U.S. Cl. CPC H01M 10/0565; H01M 2300/0002; H01M 2300/0085

(57) ABSTRACT

The present invention relates to an energy storage device comprising a positive electrode, a negative electrode, and an aqueous polymer electrolyte disposed between the positive electrode and the negative electrode. At least one of the electrodes is an organic electrode. The aqueous polymer electrolyte comprises a metal ion component comprising a metal cation being Na⁺ or K⁺; a polymer or copolymer comprising at least one monomer unit being a carboxylic acid. At least 20 mol-% of a total amount of monomers in the polymer is monomers comprising carboxylic acid.

### TECHNICAL FIELD

The present invention relates to energy storage devices, e.g. organic electrochemical energy storage devices; and to a use of an aqueous polymer electrolyte in an organic electrochemical energy storage device.

### BACKGROUND

Electrochemical energy storage (EES) devices, such as batteries, supercapacitors and pseudocapacitors, have shown wide variety of applications ranging from household electronics and electrical vehicles. Lithium ion-based batteries (LIBs) are the most used EES devices specially in portable devices owing to its high operating potential, specific energy and light weight.

However, due to the extensive demand, the price of lithium is growing exponentially which has pushed worldwide researches to find out alternate alternative battery solutions having similar electrochemical potential and chemical properties.

Electrolyte solutions play a key role in EES devices and significantly impact capacity, cyclic stability, self-discharge, cost and safety. Although organic electrolyte based batteries displays high operating potential and specific energy, there exist substantial concerns related to their flammability, toxicity and cost. On the contrary, aqueous electrolytes have been regarded as a potential alternative to organic electrolytes in terms of safety, non-flammability and cost but their application is limited by the narrow electrochemical stability window (ESW) (1.23 V) due to the decomposition of water dictated by hydrogen and oxygen evolutions which lowers the specific energy of cell (E = QV where E is specific energy, Q is charge density and V is operating potential window of cell).

To enhance the ESW of aqueous electrolytes various strategies such as use of hybrid electrolyte systems, water in salt (WIS) based electrolytes etc. have been developed recently. However, in most strategies fluorine-based anions such as bis(trifluoromethanesulfonyl)imide (TFSI⁻) anion has been utilized which is toxic for life and environment.

EES devices can be partly or completely organic. For example, lignin can be utilized as electrode materials. Lignin is one of the most abundant nontoxic biopolymer on earth as it comprises 25-30% of the total mass of wood. It is produced in large amount as byproduct of industrial processing of pulp and production of cellulosic fuels.

Organic EES devices operate at low pH with acidic electrolytes. Operating a device at low pH is problematic since most metallic current collectors will corrode, hence limiting the electrode materials to expensive noble metals. Also, organic EES devices generally suffer from relatively high self-discharge rates.

WO2019/002216 discloses an aqueous polymer electrolyte which provides a widening of the electrochemical stability window. However, WO2019/002216 is merely related to lithium-ion battery systems.

Therefore, there is a need in the energy storage industry for improved EES systems, and in particular for improved EES devices.

### SUMMARY

An object of the invention is to provide an electrochemical energy storage device comprising a non-flammable, non-toxic electrolyte, having improved electrochemical properties and which limits the amount of corrosive liquids in the device. This object of the invention, as well as other objects apparent to a person skilled in the art after having studied the description below, are accomplished by an EES device comprising a positive electrode, a negative electrode, and an aqueous polymer electrolyte disposed between the positive electrode and the negative electrode, wherein at least one of the electrodes is an organic electrode. The aqueous polymer electrolyte comprises:
a metal ion component comprising a metal cation being Na⁺ or K⁺;
a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof. At least 20 mol-% of a total amount of monomers in the polymer is monomers comprising carboxylic acid.

The invention solves the problem of providing an organic EES device having an improved electrochemical stability window, as well as that of providing a device in which corrosion of metallic current collectors are kept at a minimum, even for cheap, non-noble current collectors. The inventors have realized, that by providing an organic energy storage device, comprising at least one organic electrode and an aqueous polymer electrolyte, an EES device having an improved electrochemical stability window, improved self-discharge as well as an improved durability of the current collectors can be provided. Organic EES device with aqueous electrolytes are less flammable than e.g. lithium ion batteries. Moreover, the electrolyte shows unexpected high conductivity and can be regarded as a superionic electrolyte.

The term “superionic electrolyte” refers to an electrolyte having a higher conductivity than an Angell reference electrolyte, described in further detail elsewhere in this disclosure.

Herein, the term “electrochemical energy storage device” includes batteries, superconductors, supercapacitors pseudocapacitors and hybrid batteries having one supercapacitor electrode.

Organic EES device generally suffers from poor self-discharge. Herein, the term “self-discharge” refers to the time it takes for a device to reach its half potential after charging, when stored in its charged condition, decoupled from any external supply of charge or current conduction. The longer the time it takes to reach the half potential, the better the self-discharge properties. Self-discharge is typically caused by leakage current caused by parasitic reactions between the electrodes and the electrolytes in the cell. Self-discharge can in some cases be attributed to the oxygen content in the cell, or to contaminations from e.g. Fe ions from e.g. the current collectors.

The EES devices of the present invention has shown to exhibit slow self-discharge. It is contemplated that the slow self-discharge can be attributed to, in part, the high viscosity of the aqueous polymer electrolytes.

The inventors have realized that by providing an EES device comprising at least one organic electrode, such as an organic electrode based on a catechol/quinone redox chemistry, preferably an electrode comprising lignin, and an aqueous polymer electrode alleviates some of the problems associated with the acidic electrolytes commonly used for organic batteries. For example, with the aqueous polymer electrolyte it is possible to provide an organic EES device with a relatively high charge density and which exhibits clear redox peaks in the CV (cyclic voltammetry), at a neutral or near neutral pH of the electrolyte. Thus, problems associated with acidic electrolytes such as corrosion of the current collectors can thus be alleviated.

Herein, the terms “positive electrode” (or “positrode” or “cathode”) and “negative electrode” (or “negatrode” or “anode”) are known to the person skilled in the art. The term “organic electrode” refers to an electrode which comprises at least one organic redox active material, such as a biobased or synthetic polymer material comprising at least one redox active material. The polymer materials may be conducting or non-conducting polymers. In order to provide sufficient conductivity, the organic electrodes may further comprise an electronically conducting material, such as various carbons preferably carbon nano tubes (CNT), graphene or carbon black (ketjen black). Conducting polymers such as polypyrrole and PEDOT are examples of organic positive electrode materials, and may also be used to increase the conductivity of the positrode. The electrode may further comprise additives that may not be conductive and might not contribute to redox activities such as binders, viscosity modulating agents, pH buffers and anti-cracking agents etc.

At least the positive organic electrode may comprise a wood derived biopolymer, such as lignin. Lignin is one of the most abundant nontoxic biopolymer on earth as it comprises 25-30% of the total mass of wood. It is produced in large amount as byproduct of industrial processing of pulp and production of cellulosic fuels.

Lignin comprises large amounts of redox active catechol groups that can be electrochemically oxidized and reduced via a two-electron process. In aqueous acidic solutions, quinone/catechol couples generally provide a reversible single step two-electron/two-proton redox reaction process, making it suitable for energy storage applications. The lignin of the present invention may be lignosulfonate (LS), organosolv lignin or kraft lignin, such as LS, organosolv lignin or Kraft lignin that have been chemically modified; or other sources of catechol containing biopolymers. Even when chemically modified, the lignin of the present invention should include redox active catechol groups. Electrodes are typically prepared from lignin and other electrode materials in water and processed into electrodes by a slurry coating method, such as bar coating, followed by thermal drying and pressing.

The negative electrode should preferably be capable of electrochemical redox reactions at negative potentials. Negative electrode materials suitable for use in the present invention include polyimide, carbons and non-conducting and conducting polymers, such as PEDOT. Polyimide has proven to be a particularly advantageous in that it provides facile synthesis, exceptional mechanical and thermal properties and non-toxicity. Furthermore, it exhibits excellent electrochemical redox properties, at negative potentials in aqueous electrolyte. Thus, polyimides contain conjugated carbonyl groups that can undergo a reversible two-electron redox reaction through an enolization mechanism with monovalent cations (H⁺, Li⁺, Na⁺) as well as to coordinate divalent cations (Ca²⁺, Mg²⁺) to the carbonyl/enol groups. Its activity at negative potential in aqueous electrolytes makes it complementary to the lignin redox potential and hence could work as negatrode in the electrochemical energy storage device, in particular when the positrode comprises lignin as the redox active electrode material, such as desulfonated lignosulfonate (DLS).

In some examples, the positive electrode comprises an organic electrode comprising redox active catechol groups and the negative electrode comprises polyimide. Both electrodes may further comprise carbon, such as carbon black, to increase their conductivity.

In some examples, the positive electrode comprises lignin, such as desulfonated lignosulfonate, and the negative electrode comprises polyimide. Both electrodes may further comprise carbon, such as carbon black, to increase their conductivity.

As used herein, the term “polymer component” refers to any polymer comprising at least the referred to monomer or its homo or copolymers. The term monomer refers to the repeat units in the polymer.

The term “metal ion component” refers to a compound comprising a metal cation, or to the metal cation alone. The metal ion component may be an organic or inorganic salt of the respective metal cation. The metal ion component alternatively may refer to the presence of the metal cation itself, for example in embodiments of a negatively charged polymer providing the anionic counterpart.

The polymer component and the metal ion component may form admixtures, such as one polymer repeat unit mixed with one or more metal ion components, for example in a region where water molecules interact with both components via its oxygen atoms or via hydrogen bonds, or may form a complex of one or more compounds of each sort, such as two single charged repeat unit complexing a twofold positively charged metal cation. Or the polymer component and the metal ion component may form a polymer salt for example comprising a one-fold positively charged metal cation as counter ion for each one-fold negatively charged repeat unit.

A polymer comprising negatively charged repeat units (monomers) and a metal ion component consisting of metal cations may form a polymer salt, wherein the metal cation provides the counter compound for anionic repeat units. In embodiments where the polymer component comprises repeat units not providing a negative charge, the metal ion component preferably is provided as a salt comprising the metal cation and also its counter anion.

Herein, the metal component may comprise K⁺ or Na⁺, or Ca²⁺. The term “metal component” includes a compound comprising respective metal cations or to the metal cation alone. The metal ion component may be an organic or inorganic salt of the respective metal cation. The metal ion component alternatively may refer to the presence of the metal cation itself, for example in embodiments of a negatively charged polymer providing the anionic counterpart.

The polymer component of the present invention comprises a polymer or copolymer comprising at least one monomer unit being a carboxyl acid, such acrylic acid, methacrylic acid, maleic acid, or a carboxylate thereof and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof. The polymer electrolyte may also comprise polymer salts said polymer or copolymer and a metal cation being K⁺ and Na⁺. Preferably, the repeat unit is selected from -[CH₂CHCOO⁻]- and/or -[CH₂CHCOOH]- and mixtures thereof.

The term “carboxylic acid” is intended to denote also deprotonated carboxylate anions having the functional group [COO⁻].

The length and molecular weight of the polymer component can vary. In embodiments, the polymer component comprises in a range of ≥ 2 to ≤ 50,000 repeat units, preferably in the range of > 10 to ≤ 40,000 repeat units, more preferably in the range of ≥ 20 to ≤ 4,000 repeat units.

In embodiments, the polymer component may have a weight-average molecular weight M in the range of > 1,000 g/mol to < 3,000,000 g/mol, preferably in the range of > 2,000 g/mol to < 300,000 g/mol M. may be determined by light scattering. In further embodiments, the polymer component may have a viscosity-average molecular weight M_{w} in the range of 1,000 g/mol to < 3,000,000 g/mol, preferably in the range of > 2,000 g/mol to < 300,000 g/mol. M_{w} may be determined by dilute solution viscometry at a temperature of 20 ± 2° C.

In embodiments, at least 30 mol-%of a total amount of monomers in the polymer is monomers comprising carboxylic acids, such as at least 40 mol-%, such as at least 45 mol-%, at least 50 mol-%, at least 55 mol-%, at least 60 mol-%, at least 65 mol-%, at least 70 mol-%, or at least 75 mol-%, or preferably at least 80 mol-%. The remaining monomer units may be selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mixtures thereof.

In some examples, the polymer component comprises poly(acrylic acid) (PAA), poly(methyl vinyl ether-alt-maleic acid) (PMVMA), poly(acrylic acid-co-maleic acid) (PAAMA), polymethacrylic acid (PMAA) poly(ethylene-co-acrylic acid), poly(N-isopropylacrylamide-co-methacrylic acid), sulfonated polyacrylic acid copolymer [CAS No. 40623-75-4]. These polymers are cheap, commercially available and relatively non-toxic.

In some examples, the aqueous polymer electrolyte further comprises additional polymers, thereby forming a mixture of polymers. Mixtures includes mixtures of different polymers with high content of carboxylic acids such as polyacrylate and CMC and mixtures of polymers with high content of carboxylic acids with other polymers. The purpose of adding other polymers could be for example to modify the viscosity, freezing point or conductivity of the electrolyte. This may for example be achieved by addition of (poly) ethylene glycol.

The electrolyte may further comprise additional salts, such as potassium acetate or sodium acetate.

The electrolyte may further comprise additional additives, intended to adjust the pH of the electrolyte, or to function as wetting agents or anti-cracking agents. Such additives are known to a person skilled in the art.

In some embodiments, the metal component is K⁺. Application of K⁺ ions are beneficial because solvated K⁺ ions possess small Stokes radii which eventually improves the ionic conductivity of electrolyte in comparison to Na⁺ ion-based electrolytes. Furthermore, the K⁺ shows advantages to Li⁺ due to its higher abundance.

In some embodiments, both electrodes may be organic electrodes. Organic electrodes offer design flexibility due to the rich chemistry of organics while being eco-friendly and potentially cost efficient. The also offer an alternative to lithium-based electrodes.

In some embodiments, the positive electrode comprises lignin. Thereby, utilizing one of the most abundant nontoxic biopolymers. In further embodiments, the positive electrode may comprise lignosulfonate (LS), preferably desulfonated lignosulfonate (DLS). DLS has, because of its reduced number of hydrophilic groups, an increased hydrophobicity compared to LS. This decreases the solubility of lignin into the aqueous electrolyte. LS can be desulfonated by hydrolysis of its sulfonic acid groups.

In some embodiments, the positive electrode comprises a polythiophene polymer, such as poly(3,4-ethylenedioxythiophene) polystyrene sulfonate (PEDOT:PSS). PEDOT:PSS is a mixture of poly(3,4-ethylenedioxythiophene) and sodium polystyrene sulfonate. PEDOT:PSS is polymer material comprising at least one redox active material. PEDOT:PSS has proven to provide an advantageous organic electrode material suitable as the positive electrode in an energy storage device.

In some embodiments, the positive electrode comprises inorganic electrode materials such as a metal hexacyanoferrate (MHCF), preferably iron hexacyanoferrate (FeHCF) or nickel hexacyanoferrate (NiHCF). When the positive electrode comprises an inorganic material, the negative electrode may comprise an organic redox active material. Such materials are described elsewhere in this application, but includes PEDOT:PSS and PACA:PEDOT.

In some embodiments, the negative electrode comprises polyimide. The polyimide offers a polymer with facile synthesis, exceptional mechanical and thermal properties, and nontoxicity. Furthermore, its activity at negative potential in aqueous electrolytes makes it complementary to the lignin redox potential.

In some embodiments, the negative electrode comprises an anthraquinone polymer, such as poly(1-amino-5-chloroanthraquinone) (PACA). The PACA is preferably blended with conductive poly(3,4-ethylenedioxythiophene) (PEDOT) forming a polymer blend PACA:PEDOT, yielding a device with high specific capacity. Both PACA and PEDOT are redox active polymer materials.

In some embodiments, one of the electrodes, preferably the negative electrode, comprises redox active triazine based polymer, such as materials synthesized by a reacting melamine and a pyromellitic dianhydride or a naphthalene tetracarboxylic dianhydride.

In some embodiments one of the electrodes, preferably the negative electrode, comprises an electrode material in which the faradic or capacitive charge is a carbon material, such as activated carbon, graphite or hard carbon. Such electrode materials may comprise at least 50%, by weight, of a carbon material, such as at least 50% of activated carbon, graphite or hard carbon. Preferably, the electrode material may comprise at least 60%, by weight, of a carbon material, such as of at least 70% by weight, of a carbon material, more preferably of at least 80%, by weight, of a carbon material, most preferably of at least 90% by weight, of a carbon material. In some examples, such electrode material may consist of carbon material and up to 5 %, by weight, of naturally occurring impurities.

In some embodiments, the positive electrode comprises at least one material selected from the list consisting of lignin, chemically modified lignin, polythiophene polymer, and metal hexacyanoferrate (mHCF); and the negative electrode comprises at least one material selected from the list consisting of selected from the list comprising polyimide, anthraquinone polymer, a triazine based polymer, a ferrocene material or a carbon material. EES device comprising the above materials in its electrodes has shown advantageous properties with regard to e.g. self-discharge.

In some embodiments, the EES device is limited to cell voltages in the range of from 2.5 V or 2.0 V to 1.2 V. The cell voltage is the electrical potential difference between the two electrodes of an EES device comprising an electrochemical cell in the charged state.

In some embodiments, the EES device comprises an electrolyte that has a pH in the range of 5.5 - 7.0. Operating EES devices in this pH range, instead of acidic pHs, broadens the opportunities of electrode materials and/or current collector materials from only carbon or corrosion resistant expensive noble metals. Moreover, this pH range ascertains the lifetime of the lignin which is unstable in acidic conditions.

In some embodiments, the aqueous polymer electrolyte comprises at least 20 wt-% of the polymer, of a total weight of electrolyte. Having at least 20 wt-% of the polymer in the aqueous polymer electrolyte allows for a larger electrochemical potential window (ESW) as compared to diluted aqueous polymer electrolytes. In some examples the electrolyte comprises 20-50 wt-% of the electrolyte, or at least 40 wt-%.

In some embodiments, the EES device is an all-organic battery comprising an organic positive electrode and an organic negative electrode, a super capacitor, a pseudo-capacitor or a hybrid battery with one organic electrode and one supercapacitor electrode.

In some embodiments, the EES device is a fuel cell.

In some examples, there is provided an organic EES device comprising a positive electrode comprising lignin, such as modified lignin, preferably desulfonated lignosulfonate, organosolv lignin or Kraft lignin, a negative electrode comprising polyimide, an aqueous polymer electrolyte disposed between the electrodes, wherein said aqueous polymer electrolyte comprises a polymer salt of a polyacrylate and a metal cation selected from K⁺, comprising repeat units of -[CH₂CHCOOK]-. The molecular weight is typically in the range of 100-250 kDa. The electrodes should both preferably further comprise carbon, such as carbon black, to increase their electrical conductivity. The organic energy storage device can for example be an organic battery, a supercapacitor or a hybrid battery.

In some examples, there is provided an organic EES device comprising a positive electrode comprising lignin, preferably desulfonated lignosulfonate or Kraft lignin, a negative electrode comprising polyimide, an aqueous polymer electrolyte disposed between the electrodes, wherein said aqueous polymer electrolyte comprises a polymer salt of poly(methyl vinyl ether-alt-maleic acid) and a metal cation being K⁺, comprising repeat units of —[CH₂CH(OCH₃)CH(CO₂K)CH(CO₂K)]—. The molecular weight is typically about 216 kDa. The electrodes should both preferably further comprise carbon, such as carbon black, to increase their electrical conductivity. The organic energy storage device can for example be an organic battery, a supercapacitor or a hybrid battery.

In some examples, there is provided an organic EES device comprising a positive electrode comprising lignin, preferably chemically modified lignin, such as desulfonated lignosulfonate, organosolv lignin or kraft lignin, a negative electrode comprising polyimide, an aqueous polymer electrolyte disposed between the electrodes, wherein said aqueous polymer electrolyte comprises a polymer salt of poly(acrylic) acid-co-maleic acid and a metal cation being K⁺, comprising repeat units of -[CH₂CHCOOK]- and -[KO₂CCHCHCO₂K]-. -The molecular weight of the polymer may be about 3000 Da, at a distribution of monomers of 50 mol%:50 mol% The electrodes should both preferably further comprise carbon, such as carbon black, to increase their electrical conductivity. The organic energy storage device can for example be an organic battery, a supercapacitor or a hybrid battery.

In one aspect, the invention provides an aqueous polymer electrolyte comprising:
a metal ion component comprising a metal cation selected from the group consisting of Na⁺, K⁺;
a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof; wherein the monomer units comprising carboxylic acid is at least 20 mol%of the total polymer.

In some embodiments, the monomer units comprising carboxylic acid is at least 30 mol% of the total polymer, such as at least 40 mol% of the total polymer, preferably at least 50 mol% of the total polymer, more preferably at least 60 mol% of the total polymer.

In yet another aspect of the invention there is provided a method for manufacturing an EES device comprising
providing a positive electrode and a negative electrode;
arranging an aqueous polymer electrolyte between the positive electrode and the negative electrode,
   wherein
   at least one of the positive electrode and the negative electrode is an organic electrode; and
   wherein the aqueous polymer electrolyte comprises
      metal ion component comprising a metal cation being Na⁺ or K⁺;
      a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof; wherein the monomer units comprising carboxylic acid is at least 40 mol% of the total polymer.

In some embodiments, the method for manufacturing an EES device comprises the aqueous polymer electrolyte comprising
a metal ion component comprising a metal cation being K⁺;
a polymer or copolymer comprising at least one monomer unit being acrylic acid or mono-or di-substituted variants thereof; wherein the monomer units comprising carboxylic acid is at least 20 mol%of the total polymer.

In one aspect the invention provides, the use of said aqueous polymer electrolyte in an EES device comprising at least one organic electrode.

In one aspect, there is provided an energy storage device comprising a positive electrode, a negative electrode, and an aqueous polymer electrolyte disposed between the positive electrode and the negative electrode:
a metal ion component comprising a metal cation being Na⁺ or K⁺;
a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof;
wherein at least 20 mol-% of a total amount of monomers in the polymer is said carboxylic acid.

The inventors have found that the inventive electrolyte is suitable for use in energy storage devices.

In some embodiments one of the electrodes, preferably the negative electrode, comprises an electrode material where faradic or capacitive charge is stored in a carbon material, such as activated carbon, graphite or hard carbon. Such electrode materials may comprise at least 50%, by weight, of a carbon material, such as at least 50% of activated carbon, graphite or hard carbon. Preferably, the electrode material may comprise at least 60%, by weight, of a carbon material, such as of at least 70% by weight, of a carbon material, more preferably of at least 80%, by weight, of a carbon material, most preferably of at least 90% by weight, of a carbon material. In some examples, such electrode material may consist of carbon material and up to 5 %, by weight, of naturally occurring impurities.

In some embodiments, the EES device is a supercapacitor.

### BRIEF DESCRIPTION OF THE DRAWINGS

FIG. 1 depicts an exploded coin cell according to embodiments of the present invention.

FIG. 2 depicts a schematic illustration of a) desulfonation of lignosulfonate and b) polyimide.

FIG. 3A and B depicts the ESWs of all water-in-polyelectrolyte salt evaluated using glassy carbon as working electrode and a Pt mesh as counter electrode in normal and log scale, respectively..

FIG. 4 shows cyclic voltammetry (CV) for desulfonated lignosulfonate-carbon (DLS-C) electrodes (DLS-C) in PAAK electrolytes.

FIG. 5A depicts CV of DLS-C in PAAK at different scan rate ranging from 5 to 100 mV s⁻¹.

FIG. 5B depicts the relationship between cathodic peak current and scan rate to estimate the dominated energy storage process.

FIG. 5C shows separation of the diffusion-controlled currents (black marked area) and capacitive currents (grey marked area) in DLS-C at 5 mV s⁻⁻¹ sweep rate.

FIG. 5D Galvanostatic discharge plot at different current densities ranging from 100 mA g⁻¹ to 8 A g⁻¹ of DLS-C in PAAK illustrating the specific capacity of electrode.

FIG. 5E Specific capacity retention plot with number of cycles for DLS-C in PAAK.

FIG. 5F Observed OCP of half-cell up to 3 consecutive day to estimate the self-discharge of cell when charged at 1 A g⁻¹ current density up to 0.6 V vs Ag/AgCl.

FIG. 6A shows specific capacity plotted against current density for DLS-C in PAAK

FIG. 6B shows CV of DLS-C in PAAK before and after cycling

FIG. 6C shows CV of a polyimide-carbon (PI-C) electrode in PAAK

FIG. 7A shows a CV of PI-C in PAAK at different sweep rates ranging from 5 to 50 mV s⁻¹.

FIG. 7B shows relationship between anodic peak current and scan rate to estimate dominated energy storage process for PI-C in PAAK.

FIG. 7C shows separation of the diffusion-controlled currents (black marked area) and capacitive currents (grey marked area) in PI-C at 5 mV s⁻¹ sweep rate, evaluated using equation 1.

FIG. 7D shows galvanostatic discharge plot at different current densities ranging from 1 A g⁻¹ to 8 A g⁻¹ of PI-C in PAAK illustrating the specific capacity of the electrode

FIG. 7E shows specific capacity retention plot with number of cycles for PI-C in PAAK.

FIG. 7F shows observed OCP of half-cell up to 3 consecutive days to estimate the self-discharge rate when the cell was charged at 1 A g⁻¹ current density up to -0.9 V vs Ag/AgCl.

FIG. 8 shows a CV of PI-C PAAK before and after cycling

FIG. 9A shows a CV of DLS-C and PI-C normalized by mass showing the suitable potential window for device.

FIG. 9B shows a CV of fabricated all polymer based pseudocapacitor device at different sweep rates;

FIG. 9C shows a galvanostatic charge-discharge profiles of device at various current densities ranging from 100 mA g⁻¹ to 8 A g⁻¹

FIG. 9D shows a Ragone plot of the pseudocapacitive device measured in PAAK based HVAE

FIG. 9E shows a capacity retention plot of device showing long term cyclic stability performance

FIG. 10 shows the CV of a device before and after cycling

FIG. 11 shows comparative self-discharge behavior in (a) linear scale (b) log scale of devices built using different polymer electrolytes.

FIG. 12 shows Walden plot for the water-in-polyelectrolyte salt compared to other water-in-organic salt.

FIG. 13A shows symmetric supercapacitors based on activated carbon electrodes with PAAK (plain line) and EMIES (dashed line).

FIG. 13B shows a galvanostatic charge-discharge characteristics at 4 A/g for different maximum voltages (1, 1.6, 2.0, 2.8 V) that are normalized to make an easy comparison.

FIG. 13C shows the ratio of the integrated charges QC/QD for the charge curve and discharge curve with PAAK (blue) and EMIES (pink). Self-discharge curve for PAAK and EMIES charged at various voltage (1, 2, 2.8 V) during 1 h.

FIG. 14A shows a CV of carbon-lignin electrode (L-C) and and PI-C normalized by mass showing the suitable potential window for device. FIG. 14B shows a galvanostatic charge-discharge profiles of device at various current densities ranging from 100 mA g-1 to 8 A g-1. FIG. 14C shows a capacity retention plot of device showing long term cyclic stability performance.

FIG. 15A and B show a comparative CV at 5 mV s-1 scan rate and a galvanostatic charge discharge at 1 A g-1 current of C-L in PAAK and PAANa water-in-salt electrolyte (WISE), respectively.

FIG. 16A and B show a CV at different sweep rate and a GCD at different rate ranging from 0.1 Ag⁻¹ to 8 Ag⁻¹ of NiHCF in PAAK electrolyte, respectively.

FIG. 17A and B show CV at different sweep rate and a GCD at different rate ranging from 0.1 Ag⁻¹ to 8 Ag⁻¹ of PACA:PEDOT blend in PAAK electrolyte, respectively.

FIG. 18A and B show a CV at 20 mVs⁻¹ and a GCD at 0.1 Ag⁻¹ of PEDOT:PSS in PAAK electrolyte, respectively.

FIG. 19A and B CV at 20 mVs⁻¹; (b) GCD at 0.1 Ag⁻¹ of ferrocene, MnO₂, NiO, CoFe₂O₄ in PAAK electrolyte, respectively.

FIG. 20A and B show CV at 5 mVs⁻¹; (b) GCD at 0.1 Ag⁻¹ of a hybride device comprising a positive electrode comprising carbon and a chemically modified lignin and a negative electrode comprising activated carbon in PAAK electrolyte, respectively.

### DETAILED DESCRIPTION

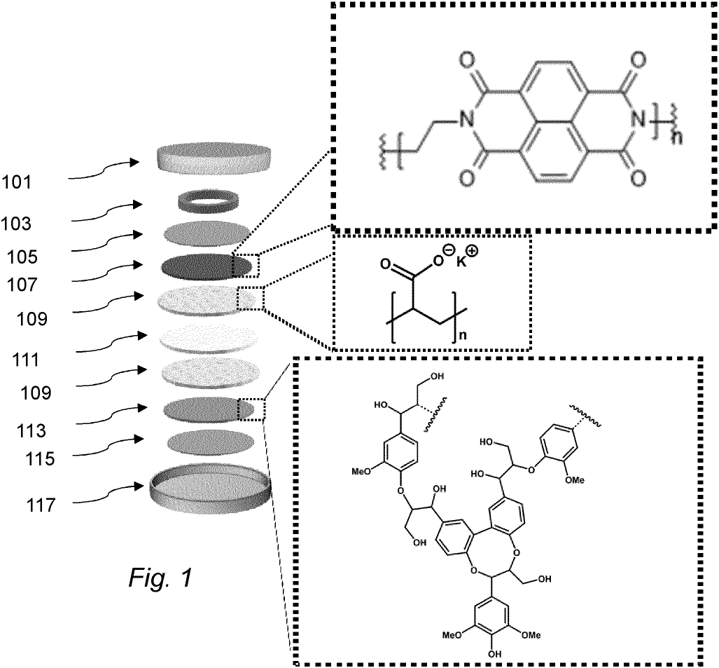

FIG. 1 shows an exploded view of an EES device comprising a top cap 101 and bottom cap 117, preferably made of stainless steel. A spring 103 is provided below the top cap 101, separated from a polyimide/carbon (PI-C) electrode 107 by a spacer 105, preferably made of stainless steel. In contact with the electrode 1007 is an aqueous polymer electrolyte 109 of the present invention, preferably comprising potassium poly acrylate (PAAK), separated from the aqueous polymer electrolyte 109 by a separator 111 On the other side of the separator is a Lignin-carbon electrode 113, preferably comprising desulfonated lignosulfonate or kraft lignin. A stainless-steel spacer 115 separates the lignin electrode from the bottom cap 117.

### Examples

### Synthesis of Desulfonated Lignin (DLS)

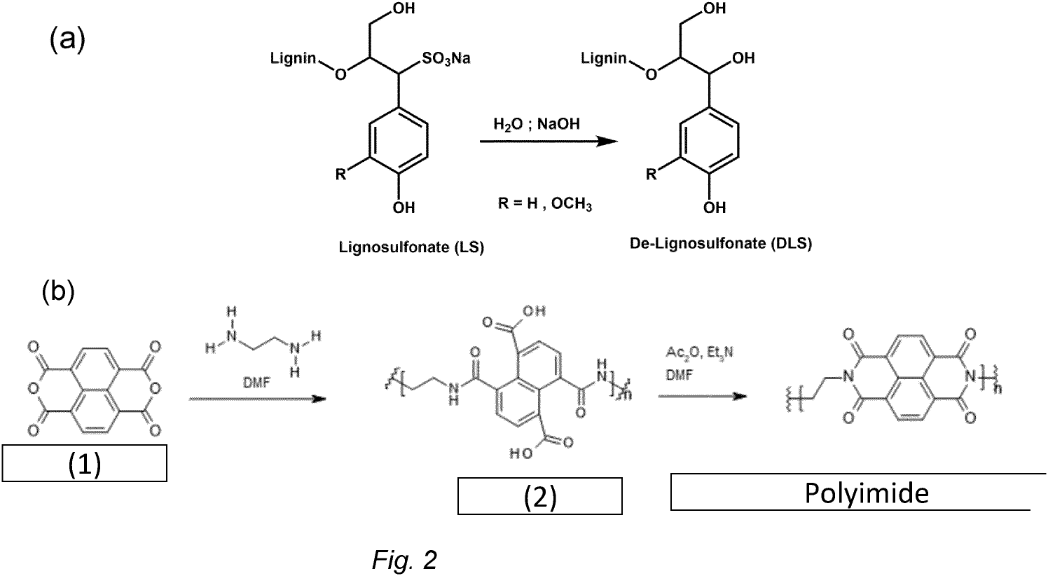

In order to improve the stability in the aqueous electrolytes, the hydrophobicity of lignosulfonate (LS) was enhanced by reducing the number of hydrophilic groups. Desulfonated lignosulfonate (DLS) was obtained by hydrolysis of sulfonic acid groups which greatly reduces the water solubility, leading to the enhancement of LS stability in aqueous solutions. Briefly, 50 g of LS and 8.0 g of NaOH were dissolved in 300 mL of distilled water and refluxed in oil bath for 5 h. The solution was then cooled to 90° C., 100 mL of 60% H₂SO₄ was added to the flask and stirred at room temperature for 2 h. Subsequently, the product was collected by centrifugation, washed twice with distilled water and dried in a vacuum chamber at 40° C. FIG. 2 depicts a schematic illustration of a) desulfonation of lignosulfonate and (b) synthesis of polyimide.

### Characterization of Lignin

Molecular weight analysis was done using with GPC (Size Exclusion Chromatography) with UV detection 256 nm. Calibration was done using polystyrensulfonate references with known MW from 122 g/mol till 679 000 g/mol. Samples were dissolved and diluted in eluent (borate buffer + 10% MeOH). Columns SB-802.5 HQ, SB-803 HQ and SB-804 HQ (Shodex) was used for HPLC-analysis. Molecular weight of LS is MW = 11.4 kDa and Mn = 1.1 kDa and for DLS the MW = 41 kDa and Mn = 1.4 kDa.

Total sulfur (Sₜₒₜ) content was measured using elementary analysis Sulfate content (S_{SO4}) was measured by titration. Sulfonic acid (S_{SO3}) content was assumed to be S_{SO3} = Stot - S_{SO4}.

The sulfonate content was determined to 5 wt% for LS and after desulfonation the sulfonic acid content was reduced with 20%.

### Synthesis of Polyimide

### Poly(amic acid)

Naphthalenetetracarboxylic dianhydride (1) (2.15 g, 8.02 mmol), 1,2-ethylene diamine (0.535 ml, 0.481 g, 8.02 mmol) and 75 ml DMF were mixed together and stirred under nitrogen using a magnet stirrer. The temperature was gradually heated to reflux under 1 h and then continue heated overnight. The reaction mixture was cooled to room temperature and the precipitate was washed with toluene three times and ethanol three times and dried under vacuum to yield (2) in quantative yield. Note that some polyamic acid is converted to polyimide. Full conversion to polyimide is achieved after cyclization in acetic anhydride.

### Polyimide

To a mixture of poly(amic) acid as prepared above (2.63 g, 8.02 mmol) in 75 ml of DMF, acetic anhydride (3.0 mL, 3.24 g, 31.7 mmol) and triethylamine (3.87 mL, 2.81 g, 27.8 mmol) was added. The mixture was stirred at 90° C. for 6 hours under nitrogen. The mixture was cooled to room temperature and the precipitate was washed with toluene three times, ethanol three times and acetone three times and dried under vacuum to yield polyimide in >90% yield.

### Preparation of PAAK Based High Voltage Aqueous Electrolyte (HVAE)

25 mL polyacrylic acid (35 wt% in water) was neutralized by 0.01 M KOH solution. This solution was stirred for 24 h and then water was removed by heating at 80° C. temperature. Thereafter, the obtained salt was used to prepare PAAK based HVAE in 1:2 (wt-ratio) with water. Other polymer solutions were prepared according to the same method.

### EES Device Preparation

### Current Collector Preparation

25 µm-thick stainless steel (SS 316L) foils were used as the current collectors as well as the substrates. SS 316L foils were washed in 3 M HCl for 3 min and then rinsed twice in DIW. After acid washing, one side of the SS 316L foil was coated with a layer of colloidal carbon (CC) using a wire-bar coater (RK K-Control Coater) with the wet film thickness of 4 µm and dried at 110° C. for 1 hour.

### Electrode Preparation

The activated carbon slurry was prepared by mixing carbon black (ketjeen black EC600JD), activated carbon YP50F, and CMC-SBR mixture (binder) in a weight ratio of 4.5:4.5:1 with deionized water (15 ml) using a high shear mixer (IKA T-25 digital ULTRA-TURRAX) creating a homogeneous slurry. The slurry was coated with a 300 micro-meter wet thickness using film applicator (Sheen Instrument), dried at 80° C. for 1 hour and pressed using a Durston DRM 130 roller press. The pressed material was cut to coin cell electrode format to give activated carbon electrodes.

The PACA:PEDOT and metal hexacyanoferrate e.g. nickel hexacyanoferrate (NiHCF) was prepared by mixing the active electrode material with ketjeen black (EC600JD) and PVDF in a 70:25:5 wt% ratio in NMP. The slurry was coated on metal current collector and dried at 80° C. for overnight.

Electrodes comprising metal oxides and ferrocene was prepared according to the following procedure. Redox active materials were mixed with ketjeen black (EC600JD) in a 50:50 wt% ratio in water and coated on metal current collector and dried at 60° C. for 1 h.

### Carbon-Desulfonated Lignin Electrodes (DLS-C electrodes)

The lignin positive electrode slurry was prepared by mixing modified lignin e.g. desulfonated lignosulfonate and ketjeen black (EC600JD) with water using a high shear mixer (IKA T-25 digital ULTRA-TURRAX). Carboxymethy cellulose (CMC) and a dispersion of styrene-butadiene rubber was added so that the dry weight ratio was typically (47:47:2:4):(DLS:KB:CMS:SBR). Water was added during shear mixing to adjust solid content to approximately 25 wt%. The slurry was coated with a 300 micro-meter wet thickness using film applicator (Sheen Instrument), dried at 60° C. for 1 hour and pressed using a Durston DRM 130 roller press. The pressed material was cut to coin cell electrode format to give DLS-C electrodes.

### Carbon-Polyimide Electrodes (PI-C electrodes)

For the negative electrode slurry, polyimide and ketjeen black (EC600JD) was prepared using same methodology as for the positrode electrode slurry using a weight ratio of (62:31:2:4):(polyimide:ketjeen black:CMS:SBR). Water was added during shear mixing to adjust solid content to approximately 30 wt%. The slurry was coated with a 200 micro-meter wet thickness using film applicator (Sheen Instrument), dried at 60° C. for 1 hour and pressed using a Durston DRM 130 roller press. The pressed material was cut to coin cell electrode format to give PI-C electrodes.

For two electrode measurements, 2032 coin cells were assembled from electrode material and electrolytes describe in invention and Celgard 5550 membrane as separator material (FIG. 1).

### Electrochemical Characterization

### Electrochemical Stability Window (ESW)

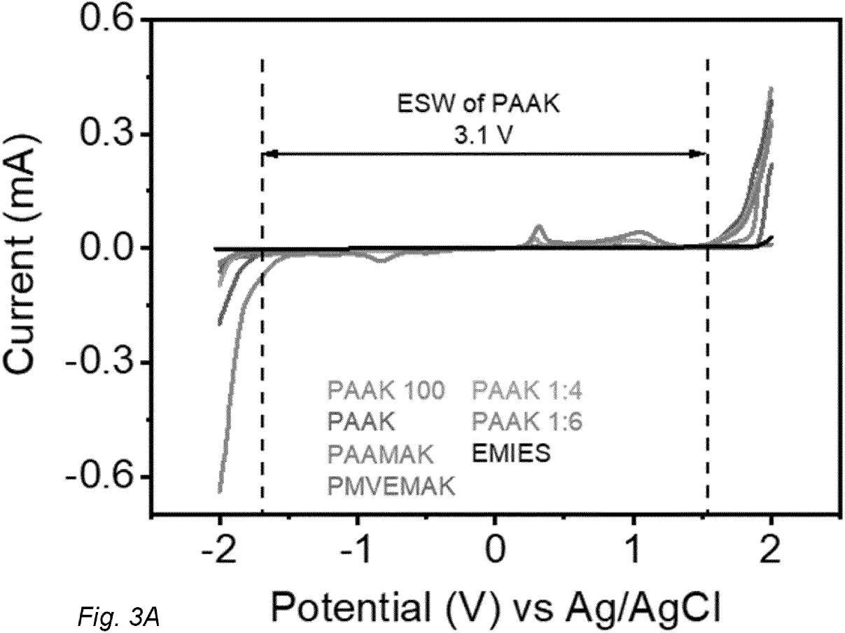

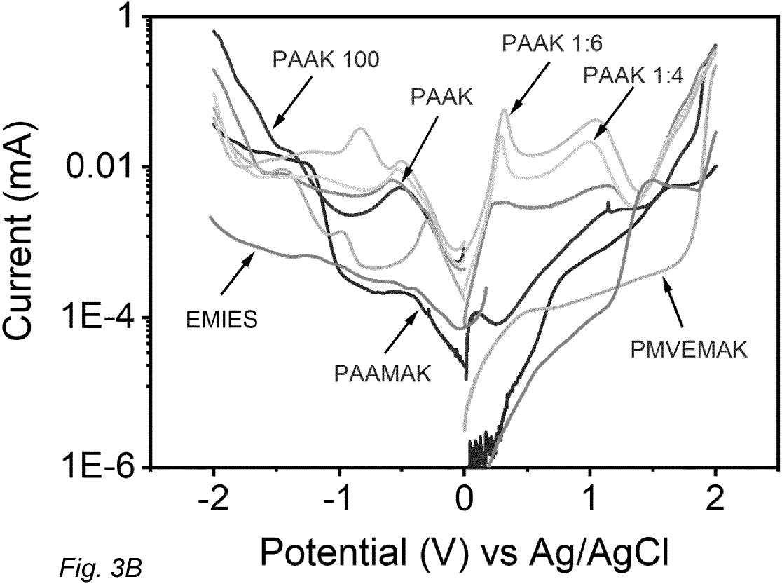

The ESW of the prepared PAAK polymeric electrolyte was determined using a three-electrode cell setup including glassy carbon as the working electrode (WE), a Pt mesh served as the counter electrode (CE) and Ag/AgCl was used as the reference electrode (RE). The electrolyte stability was analyzed within the -2.0 V to +2.0 V potential by monitoring the current evolution recorded from linear scan voltammetry (LSV) measurements. For anodic scans, an exponential increase of the current is observed after 1.5 V vs Ag/AgCl however, in cathodic direction evolution starts after -1.6 V vs Ag/ (FIG. 3). Thus, it was concluded that the PAAK electrolyte has an ESW of 3.2 V that do not involve any significant parasitic reactions such as oxygen evolution reaction (OER) and hydrogen evolution reaction (HER).

### Self-Discharge Analysis of Cell

Self-discharge of half-cells were analyzed by charging at 1 A g⁻¹ current density to optimum potential, followed by holding the charged potential up to 1 h and then measuring open circuit potential (OCP) for 3 days. For device, the cell was charged at 0.1 A g⁻¹ up to 1.7 V and chronoamperometry (CA) was carried out for 1 h. Thereafter, OCP of cell was observed for 5 days.

### Self Discharge of DLS-C and PI-C Based All Polymeric Pseudocapacitor Device

Most of the aqueous organic batteries suffers with of poor self-discharge which may originate due to the leakage current caused by OER or HER as parasitic reactions. Therefore, to evaluate the self-discharge characteristic of DLS-C and PI-C based all polymeric pseudocapacitor device, the cell was charged at 0.1 A g⁻¹ and its OCP was observed up to 5 days, confirming the stability of the cell.

### Electrochemical Characterization of DLS-C in PAAK as Positive Electrode

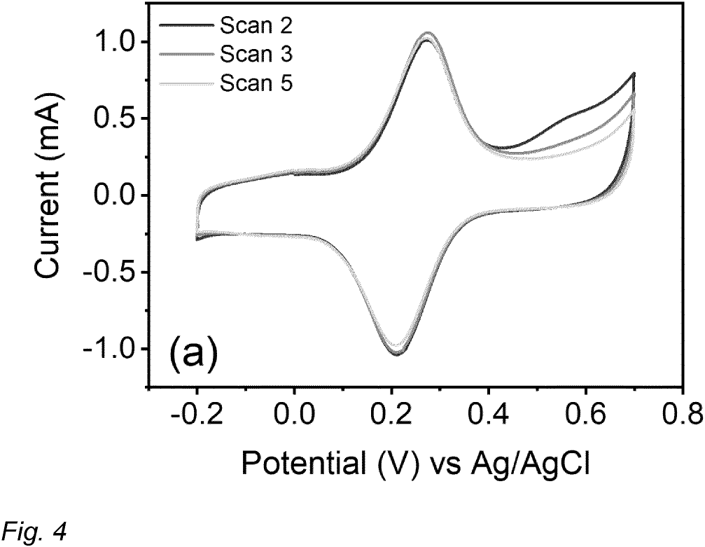

LS contains several carboxylic acid and sulfonic acid groups which are hydrophilic in their nature. These functional groups make LS soluble and processable in water, which could be desirable from a manufacturing point of view. However, this also impacts the electrochemical performance and long-term stability of a resulting pseudocapacitors, based on an aqueous electrolyte, that includes LS as the redox systems on the positrode side. To avoid performance degradation, related to dissolution/instability, desulfonation of LS was carried out which then allows for the fabrication of stable positive electrodes. Half-cell electrochemical characterizations for DLS-C was carried out in PAAK-based HVAE and the cyclic voltammetry (CV) experiment was performed at 5 mV s⁻¹ (FIG. 4). In PAAK, DLS-C displayed a pair of redox peaks, in agreement to previous reports, at 0.27 V and 0.21 V vs Ag/AgCl that are associated with oxidation and reduction of lignin, respectively. These redox peaks were found to be reproducible during cycling, which indicates that lignin is electrochemically active and, importantly, reversible in PAAK.

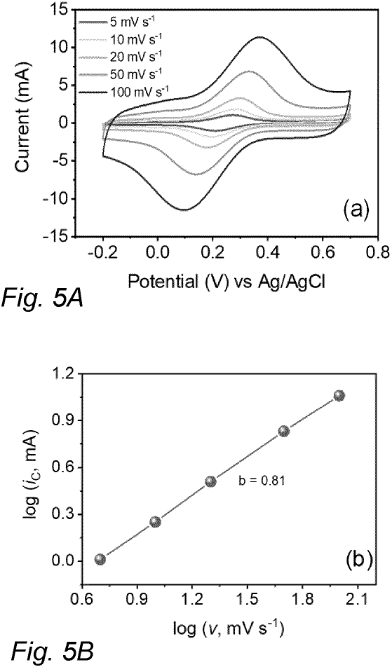

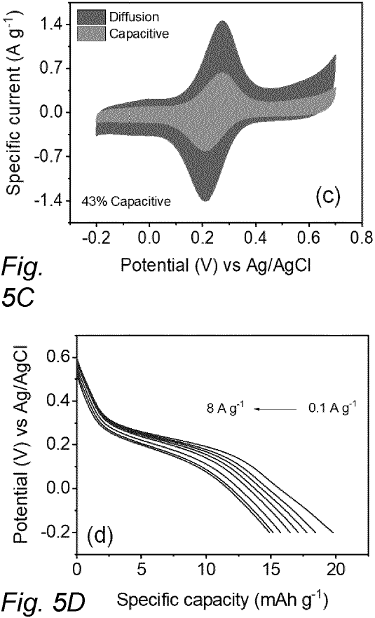

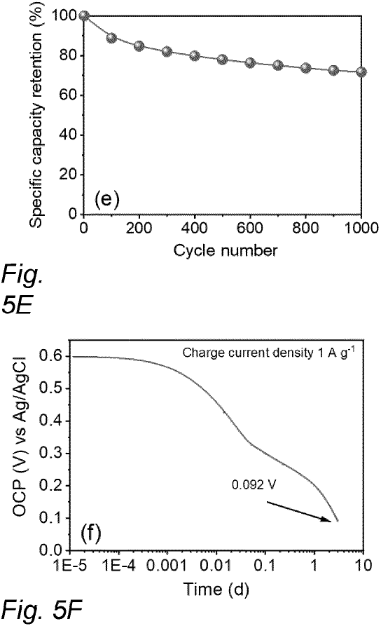

Further, the redox behavior of DLS-C in PAAK was investigated at higher scan rates ranging from 10 to 100 mV s⁻¹ (FIG. 5A). The appearance of redox peaks at higher scan rates suggest that the kinetics of interfacial faradic reactions and ionic transports in the PAAK are swift also at higher scan rates. However, a shift of redox peaks with increased sweep rates is observed, which is due to the internal resistance of the electrode. To understand the fundamentals of the charge storage mechanism in the DLS-C, whether its faradaic or non-faradaic, the dynamic electrode performance in relation to the power law i = av^{b} (where i is peak current, v is scan rate, and a and b are constants) was evaluated. b was estimated from the slope of log(i) vs log(v) plot, which resulted in a value varying from 0.5 to 1. For b close to 0.5, the dynamics of the electrode performance is dictated by a diffusion-limited process, and if b reaches close to 1, then the mechanism is dominated by a capacitive process. Herein, for the DLS-C electrode in PAAK, the slope was found to be 0.81 (FIG. 5B) which indicates that energy storage process is dominated by (surface) capacitive process (of the C component) in combination with a diffusion-limited process originating from the Faradic redox processes of lignin. Further, the capacitive (k₁) and diffusion (k₂) controlled contribution to total capacity at a specific voltage can then be estimated from CV using the following equation (1)

$$i = {k}_{1} v + {k}_{2} {v}^{1 / 2}$$

where i is the current (A g⁻¹) and v is the sweep rate (mV s⁻¹). FIG. 5C illustrates the typical separations of capacitive and diffusive currents at the sweep rate of 5 mV s⁻¹. It was found that 43% of the total stored charge in the DLS-C electrode, over a full switch cycle, is due to a capacitive process.

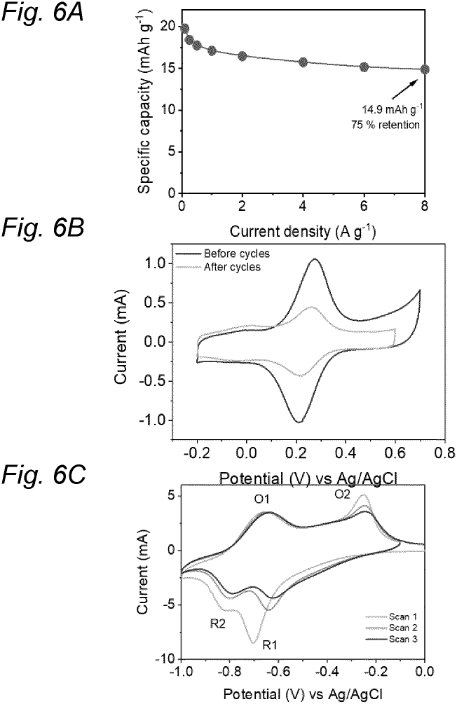

To calculate the specific capacity of DLS-C in PAAK electrolyte, three electrode galvanostatic charge-discharge measurements were carried out at different current densities, ranging from 100 mA g⁻¹ to 8 A g⁻¹. All discharge curves show a plateau in the 0.3-0.1 V vs Ag/AgCl range due (FIG. 5D). The specific capacities of the DLS-C electrode are 19.8, 18.4, 17.7, 17.1, 16.5, 15.7, 15.2 and 14.9 mAh g⁻¹ for the different current densities, respectively. It is worth to mention that the DLS-C composite displays a maximum capacity of 19.8 mAh g⁻¹ at 100 mA g⁻¹ current density. However, by increasing the current 80 times (i.e. reaching 8 A g⁻¹) the specific capacity reduces only by 25% (14.9 mAh g⁻¹ of specific capacity), which indicates a remarkable rate capability of the DLS-C electrode operating in the PAAK electrolyte (FIG. 6A). The electrochemical stability of the DLS-C electrode was examined by performing constant current charge-discharge (current density 1 A g⁻¹) up to 1000 cycles. The specific capacity drops only 28% while passing 1000 cycles, thereby suggesting that DLS-C is electrochemically reversible and also stable in PAAK (FIG. 5E). CV was then carried out again to examine changes in redox activity of DLS-C before and after cycling. Indeed, there is a decrease in the redox peak current after 1000 cycles, but lignin appears to be still certainly electrochemically active (FIG. 6B). To investigate the potential drop of an individual electrode, self-discharge was carried out in a three-electrode configuration, because for a half-cell setup the WE potential is always measured with respect to the constant potential of RE. For DLS-C, first, the cell was charged at 1 A g⁻¹ current density reaching 0.6 V vs Ag/AgCl and, then, the OCP of half-cell was monitored for three consecutive days. After 3 days, the cell potential drops to 0.09 V, from 0.6 V vs Ag/AgCl (FIG. 5F).

### Electrochemical Characterization of PI-C in PAAK as Negative Electrode

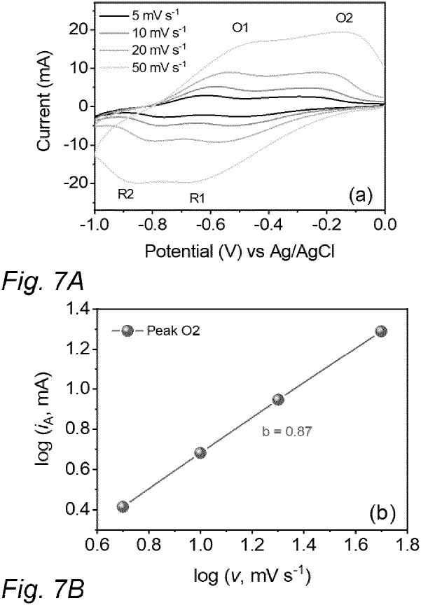

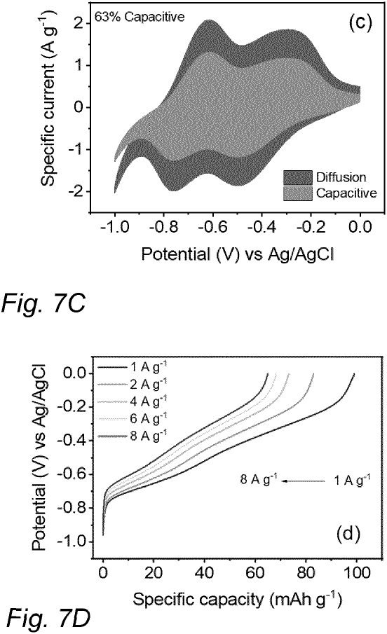

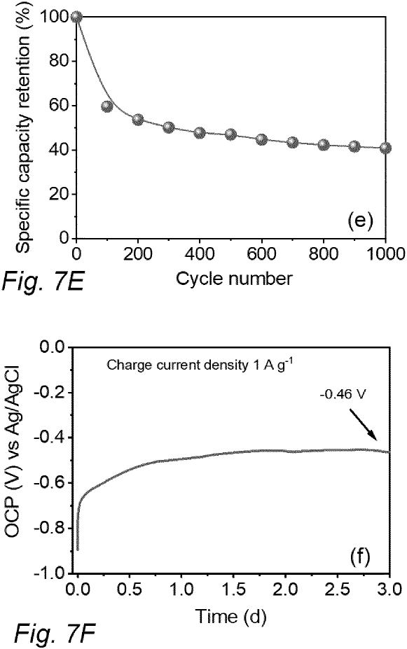

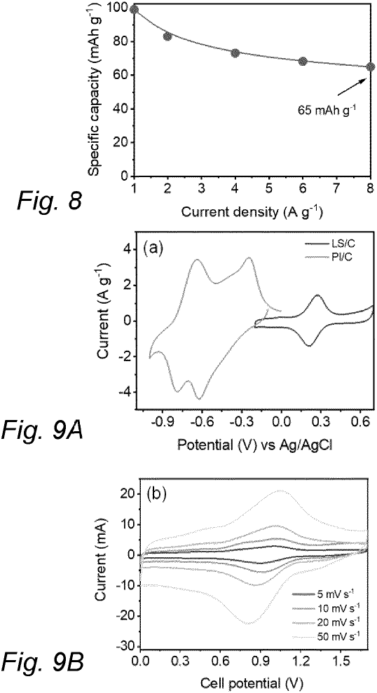

The naphthalene structure-based PI composited with carbon black was tested as negative electrode in PAAK electrolyte using CV and galvanostatic charge-discharge method with Pt mesh as CE and Ag/AgCl as RE under nitrogen atmosphere. The CV of PI-C shows two pair of redox peaks corresponding to two electron reduction processes (marked as R1 and R2 centered at -0.64 and -0.8 V vs Ag/AgCl, respectively) and two oxidation processes (marked as O1 and O2 centered at -0.25 and -0.64 V vs Ag/AgCl respectively) involving the carbonyl group (FIG. 6C). The CV of PI-C, as the scan rate is increased, gives voltammograms that maintain their overall shapes but with an increase in current (FIG. 7A). Further, the kinetics of the PI-C electrode was also analyzed with the power law. For the O2 peak, the value of b was found to be 0.87 (FIG. 7B). This value suggests that the energy storage mechanism is primarily dominated by a surface-controlled capacitive process rather than diffusion. Additionally, using equation 1, the different contributions of diffusion-controlled and capacitive processes to the total capacity was also evaluated for the PI-C. Of the total integrated current in total, 63% is regarded to as capacitive processes (FIG. 7C). Galvanostatic charge-discharge measurements, at different current densities, was then carried out to evaluate the specific capacity of the PI-C electrode in PAAK. The specific capacities of Pl-C are 99, 83.1, 73.2, and 65 mAh g⁻¹ for current densities ranging from 1 A g⁻¹ to 8 A g⁻¹ (FIG. 7D). The PI-C electrode exhibits a maximum of 99 mAh g⁻¹ specific capacity at 1 A g⁻¹ current density which decreases only ~34% when scan at 8 times higher current density demonstrates good rate capability of PI-C in PAAK. Cyclic stability was also performed to analyze the electrochemical stability and rechargeability of PI-C in PAAK electrolyte. The half-cell was charged and discharged at 1 A g⁻¹ up to 1000 cycles and found that the cell retains 40% of its initial specific capacity (FIG. 7E), validating the decent cyclability of PI-C in PAAK. PI-C shows huge capacity loss (~40%) within 100 cycles but thereafter the decay in specific capacity is gradual. CV was performed after 1000 cycles charge-discharge of cell to examine the redox behavior in PI-C after the cycle. Two pair of redox peaks can still be seen in CV of PI though, the current intensity was reduced (FIG. 8A), suggesting that PI-C might have degraded after continuous cycles. Self-discharge of PI-C in PAAK was also analyzed by charging the half-cell at 1 A g⁻¹ up to -0.9 V vs Ag/AgCl and then measuring the OCP for 3 consecutive days. In 3 days, the cell discharges only 49% and reaches to -0.46 V vs Ag/AgCl (FIG. 7F) confirming the good stability of electrode when kept in relaxed condition.

### All Polymer-Based Device Testing

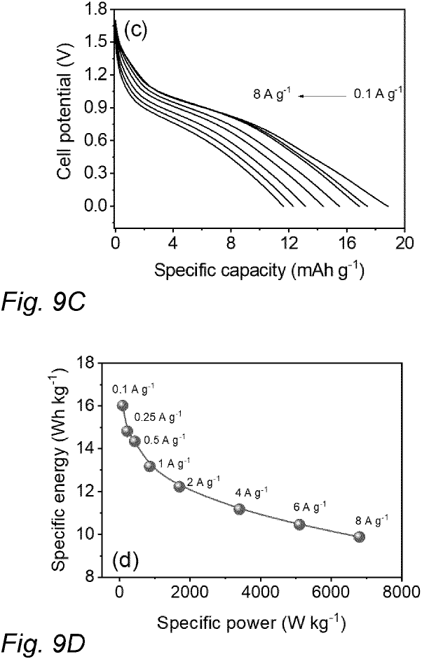

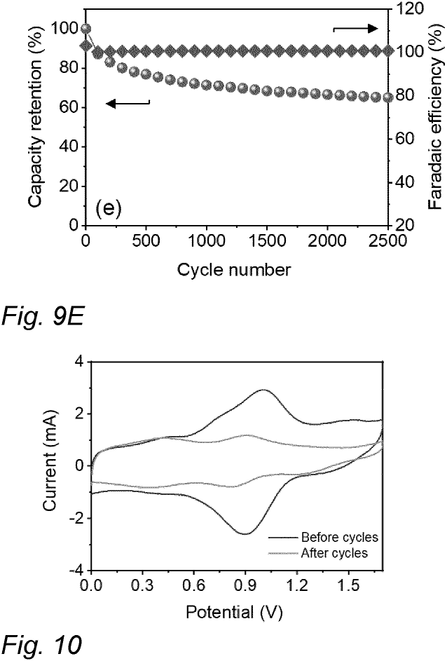

Before assembling the final device the total capacitance values (size/mass) of the positive electrode were balanced with the values of the negative one. The CVs of the positive and negative electrode normalized by mass are presented in FIG. 9A. First, these CVs suggest a stable potential window for DLS-C of -0.2 to 0.7 V vs Ag/AgCl and for the PI-C electrode this window is from 0 to -1 V, vs Ag/AgCl. The cell potential can be expressed as the sum of potential ranges of DLS-C and PI-C which is ~1.7 V. The mass ratio between the electrodes was found to be 6:1 for DLS-C and PI-C, while considering their charge storage density characteristics. An asymmetric pseudocapacitor device was then finally constructed using DLS-C as the positive electrode, PI-C as the negative electrode and PAAK as the stable HVAE. CVs was performed targeting to understand the redox performance of the resulting device at different sweep rates varies, ranging from 5 to 50 mV s⁻¹, see FIG. 9B. The voltammograms show a small peak, or feature, at around 0.5 V, in combination with one broad oxidation and one broad reduction peak, where the peaks are attributed to the oxidation and its reduction, respectively. The peak currents increase with scan rates, which suggests that the ionic and electronic charge transport, along with the interfacial redox processes, are rapid. The galvanostatic charge-discharge (GCD) measurements were carried out at different current densities ranging from 0.1 to 8 A g⁻¹ to calculate the specific capacity of pseudocapacitive device. At 0.1 A g⁻¹ current density, the discharge curve shows a plateau within the range from 1.1 to 0.7 V and then the potential drops relatively fast (FIG. 9C). The device shows a maximum specific capacity of 19 mAh g⁻¹, at 0.1 A g⁻¹ current density, a value which decreases to 11.6 mAh g⁻¹ (a 39% loss in specific capacity) as the current increases about 80 times. These results demonstrate a rather good rate capability for an all-organic pseudocapacitor device, here based on a HVAE. The evolution of the specific energy versus the specific power performance, of the resulting pseudocapacitor, is presented in the Ragone plot of FIG. 9D. The device delivers a maximum specific energy of 16 Wh kg⁻¹, at a specific power of 85 W kg⁻¹, which then reduces to 9.9 Wh kg⁻¹ at a high specific power of 6.8 kW kg⁻¹. Moreover, the cyclability of the assembled device was tested up to 2500 cycles in order to evaluate its long-term cycling stability. The device retains 65% of its specific capacity up to 2500 cycles (FIG. 9E). Subsequently, the faradaic efficiency, which describes the charge efficiency with respect to electrons are transferred of the device, was found to be 99% after 2500 cycles, indicating a relatively good long-term stability of the device while operated with the PAAK (FIG. 9E). CVs was then performed after 2500 cycles to verify and to analyze the electrochemical behavior after long-term cycling (FIG. 10). These measurements suggest a degradation in activity of the included redox materials.

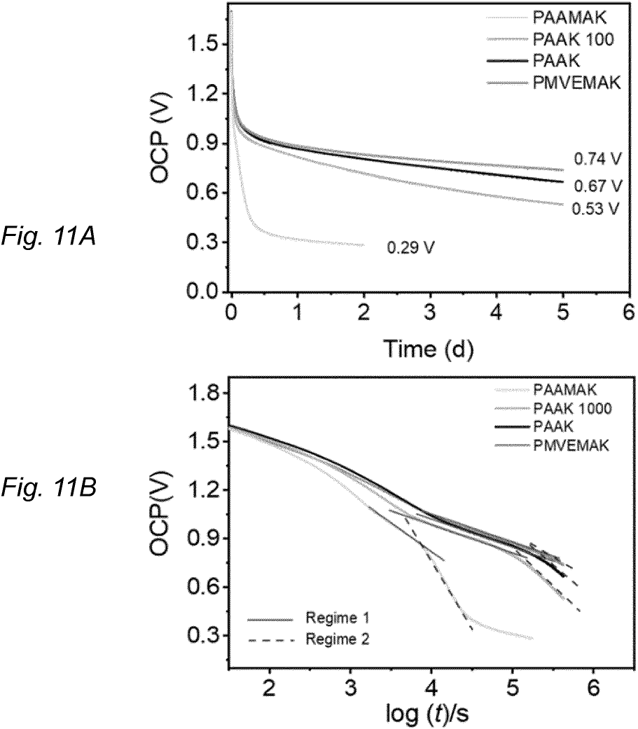

Most of aqueous (pseudo-)supercapacitor devices suffer from fast self-discharge which mainly originates from i) the ohmic leakage, ii) charge diffusion, redistribution of involved components, and/or iii) faradic reactions. To evaluate the self-discharge characteristic of an inventive all-polymeric pseudocapacitor device, the cell was first charged at 0.1 A g⁻¹ and then its OCP was monitored for 5 days. It was found that the cell potential drops to 0.67 V, starting from a value of 1.7 V, in 5 days which suggests a slow self-discharge rate, while comparing to other reports and commercial devices. This slow self-discharge is here attributed to a low leakage current that is associated with the performance of the PAAK being a HVAE. To confirm this, supercapacitors with different concentrations of the PAAK electrolyte was prepared and the resulting leakage current was measured in the -2.0 V to +2.0 V potential window using linear scan voltammetry (LSV). The resulting LSV curves for each variant are given in FIG. 3. For anodic scans, the PAAK 1:4- and 1 :6-based devices (PAAK-water wt-ratio) show clear water oxidation peaks at around 1 V, vs Ag/AgCl. This is not observed in the LSV of devices based on the 1:2-based electrolyte (PAAK-water). On cathodic scans, a peak is observed that likely corresponds to oxygen reduction reaction and is found at around -0.6 V, vs Ag/AgCl, in both 1:4- and 1:6-based PAAK electrolytes. For the 1:2-based PAAK electrolyte no such peak is observed. Therefore, is was concluded that the 1:2-based PAAK electrolyte display a relatively lower leakage current, as compared to its more diluted counter parts, which then also reduces the ohmic leakage and thus reduces the rate of self-discharge. In addition to ohmic leakage, the 1:2-PAAK electrolyte has a much higher viscosity, while comparing to the other two electrolytes, which should also slow down diffusion of ions and redox species, thus suppressing self-discharge. To further confirm the hypothesis, the self-discharge performance of the supercapacitor, now based on the DLS-C positive electrode and PI-C negative electrode combined with the PAAK 1:6 electrolyte, was studied. This device displays a relatively faster self-discharge in comparison to the 1:2-based device (FIG. 11A and B).

### Characterization of Polymer Electrolytes

Different concentration of potassium polyacrylate (PAAK) electrolytes, as well as other electrolytes described below, was prepared. Herein, PAAK was dissolved in 1:2, 1:4, and 1:6 wt-ratio with water and their ESW was investigated by linear scan voltammetry (LSV) measurements using a three-electrode cell setup under N₂ atmosphere using a glassy carbon electrode.

FIG. 3A and B display the current in normal scale and a log scale to be able to see low levels of current in those electrolytes. Redox peaks related to water decomposition are visible on both cathodic (~ -0.80 V) and anodic side (~ +0.35 V) for small PAAK/H₂O weight ratio of 1:6 and 1:4. The polymer electrolyte with 1:2 wt-ratio water did not show the redox peaks and is associated to the absence of free water molecules undergoing electrolysis. In the rest of this study, the prepared electrolytes all have a 1:2 wt-ratio with water. The prepared polymer electrolytes with 1:2 wt-ratio are (i) the fluid low molecular weight potassium salt of poly(acrylic acid-co-maleic acid), with a monomer ratio of 1:1 of acrylic acid and maleic acid, of MW = 3k (PAAMAK) with 7±0.3 mPa.s (at a 10 s⁻¹ shear rate); (ii) potassium polyacrylate of MW= 100k (PAAK 100) with 200±1 mPa.s; (iii) potassium polyacrylate of MW=250k (PAAK) with 470±1 mPa.s; and (iv) finally the gel electrolyte with potassium poly(methyl vinyl ether-alt-maleate) of MW = 1980k (PMVEMAK) with a high viscosity of 33000±60 mPa.s. For anodic scans, an exponential increase of the current is observed after 1.5 V vs Ag/AgCl, while an evolution starts after -1.6 V vs Ag/AgCl (FIG. 3A) on cathodic scans. This range of potential defines the ESW found to be more than 3 V related to reactions such as oxygen evolution reaction (OER) or hydrogen evolution reaction (HER). Their ESW gap is defined as the potential difference between the oxidative potentials of anion and reductive potential of cations and is 3.1 V for PAAK, 2.8 V for PAAK100, 3.8 V for PAAMAK (orange curve), 3.7 V for PMVEMAK. The co-polymer based polymeric electrolytes such as PAAMAK and PMVEMAK displayed low leakage current in the range [-1 V, 1 V], but similar order of magnitude outside this range, resulting in only a slightly wider ESW than PAAK based electrolytes. For the sake of comparison, the LSV of a representative ionic liquid, 1-ethyl-3-methylimidazolium ethyl sulfate (EMIES) is plotted in the same graph (black curve). It was observed that the water-based PAAMAK has the same level of leakage current between [0, -1 V] but increase by one order of magnitude for higher cathodic potential [-1, -2 V]; on the other hand EMIES has a lower leakage current than the aqueous polyelectrolyte in the range [0, +1.2 V]. Surprisingly PMVEMAK has lower leakage than the ionic liquid for more anodic potential [+1.2, +2 V] and same anodic threshold in the ESW as the IL at +2 V. Hence, it was found that various polymers possess different levels of leakage current varying over 4 orders of magnitude and some comparable with the ionic liquid.

The ionic conductivity of PAAKs was measured in a two-electrode cell by electrochemical impedance spectroscopy. The ionic conductivities of electrolytes were estimated to be 87 ± 0.2 mS/cm for PAAMAK, 58 ± 5 mS/cm for PAAK (MW=100 kDa), 74 ± 3 mS/cm for PAAK (MW=250kDa) and 45 ± 0.3 mS/cm for PMVEMAK.

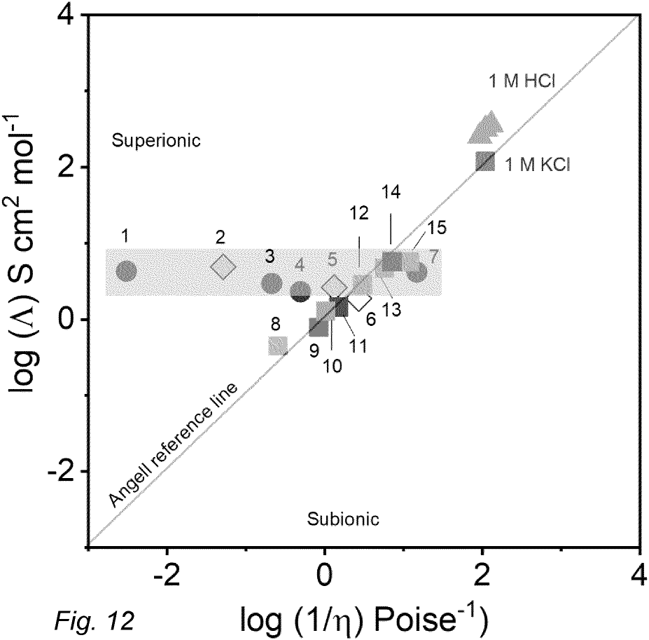

A Walden plot (FIG. 12) can be obtained by plotting log of molar conductivity vs. log of ⅟viscosity which can provide information on the regime of ionic transport, as well as for degree of ionicity of an electrolyte. In the case of diluted solutions of a fully dissociated salt, the ions are migrating with a solvation shell through a solvent, hence the ions can be represented with a certain hydrodynamic radius moving in a viscous medium and described by the Nernst-Einstein equation. In this case, the Walden plot would be a line of slope equals to 1 passing through the reference solution of 1 mol L⁻¹ KCI solution at 25° C., it is called the Angell reference line. In the Walden plot, electrolytes above [below] the reference line are called “superionic” [“subionic”] and show deviation compared to the Nernst-Einstein behavior (FIG. 12). For high concentration electrolytes, this deviation could be attributed to ion-pairing or charge correlation. Note that despite the high concentration, saturated solutions such as eutectic of potassium acetate and lithium acetate, bis(trifluoromethanesulfonyl)imide, lie close to the Angell reference line.

In FIG. 12, the reference numerals correspond to the following electrolytes: 1= PMVEMAK, 2 = PAAK (1:1 ), 3 = PAAK, 4 = PAAK 100, 5 = PAAK (1:4), 6 = PAAK (1:6) and 7 = PAAMAK, studied in current work. For comparison 8, 9, 11 and 12 are described in Energy Environ. Sci., 2018,11, 2876-2883, 10 and 14 is described in Electrochemistry Communications, Volume 116, 2020, 106764, 13 is described in RSC Adv., in J. Mater. Chem. A, 2014,2, 792-803.

It was observed that the ionic conductivity of the inventive “water-in-polymer salt” electrolytes (PAAKs) is completely different than a Nernst-Einstein behavior electrolyte, as it is constant although the macroscopic viscosity varies by close to 4 orders of magnitude. This remarkable behavior positions the viscous PAAK derivatives in the superionic regime. This observation indicates that the macroscopic viscosity does not govern the ionic transport. The conductivities obtained in the polymeric WISEs (PAAKs) (87- 45 S/cm) are larger than WISE based on molecular salts, e.g: 42 m LiTFSI + 21 m Me3EtN·TFSI with 0.91 mS/cm; 27 m KOAc with 31 mS/cm. Hence, the phenomena responsible for these unique features of polymeric WISE compared to the molecular WISE in the Walden plot are not only due to (i) a high ionicity (dissociation) of the cations and the acrylate anions, and (ii) the absence of free water molecules and solvation shells; but likely due to the transport regime. Two regimes of ionic transport can take place in polymer electrolytes. First, the ionic transport is driven by the fast dynamics of the flexible polymer chains, the ionic transport is called “coupled”, such as Li salt in polyethylene oxide. Second, the ions are transported between immobile polymer chains, i.e. the relaxation time of the conduction is smaller than the structural relaxation time of the polymer chains. In that case the transport is said “decoupled”, such as in frustrated or rigid poly[4-(2-methoxyethoxy)methyl styrene] (PMOEOMSt), and could be reduced to a hopping-like motion. In those last examples, since the polymer is the solvent for the salt, there is a high concentration of ion pairs resulting in a rather low ionic conductivity. The conductivity of the water-in-polymer salt PAAK electrolytes (74 mS/cm) is much higher than the salt-in-polymer electrolyte (10⁻¹ \-10⁻² mS/cm) and still superior than the “polymer-in-salt” electrolytes (1 mS/cm). It is contemplated that this is due to the negligible presence of ion-pairs and aggregates in our electrolytes. Hence, compared to the “salt-in-polymer” or “polymer-in-salt” electrolytes, the “water-in-polymer salt” strategy applied to PAAK leads to a large ESW, non-flammability, high ionic conductivity comparable viscosity which is advantageous for manufacturing and robustness (avoiding leakage of liquid in case of battery punching). The larger ionic conductivity of the polymeric WISE compared to organic molecular WISE suggests that the ionic transport is “decoupled” with fast ionic mobility, negligible ion-pairing or aggregations.

The flammability of the water in PAAK (2:1) ratio with the ionic liquid EMIES was compared. A glass fiber wool was loaded with the electrolyte and then a Bunsen was burning the sample for 10 seconds and turned off. From that time, the sustained period of burning for a certain weight of electrolyte was measured, to define the self-extinguishing time (SET). For PAAK, the flame is extinguished simultaneously to the Bunsen’s flame, so the SET is 0 s/g and it is classified as truly non-flammable. For EMIES, the flame continues to grow and burn even after 59 s, indicating that it is combustible.

### Activated Carbon-Based Supercapacitors

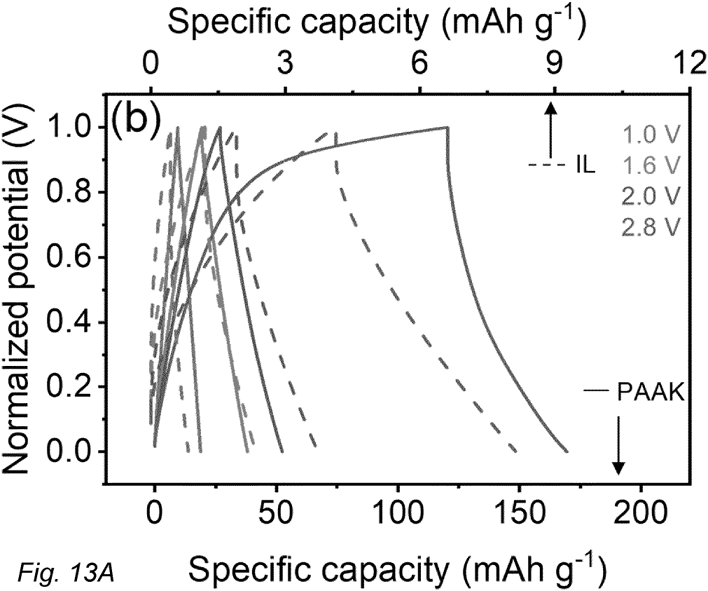

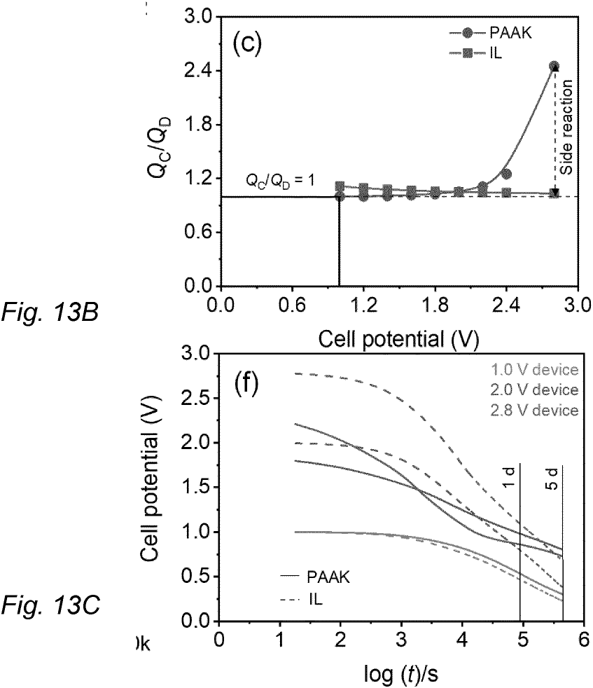

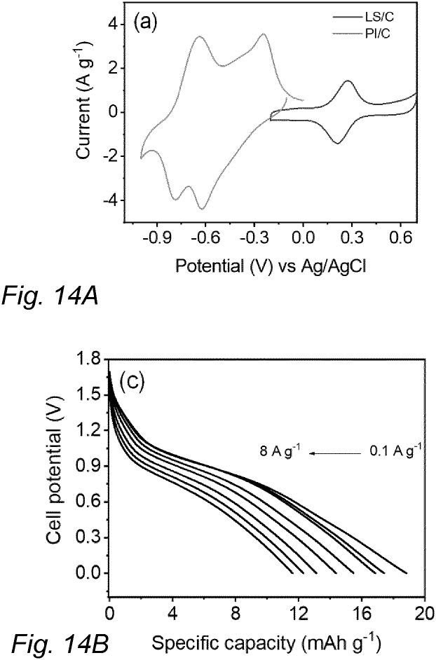

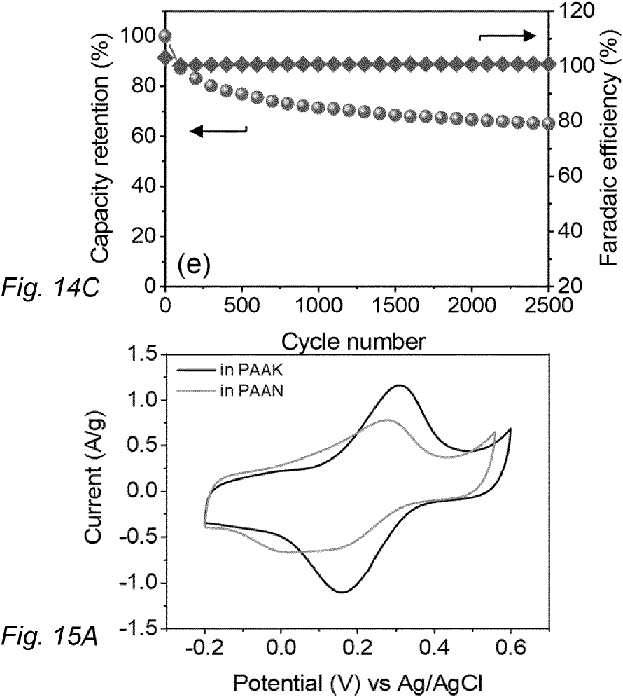

Water-in-PAAK (2:1) is tested and compared to the ionic liquid EMIES in symmetric supercapacitors composed of two activated carbon electrodes. The cyclic voltamograms (CVs) recorded for increasing voltage range from 1 V to 2.8 V display a leakage current above 2 V for PAAK, while the EMIES behaves close to an ideal capacitive square box characteristic (I=C×dV/dt, the scan rate dV/dt= 100 mV/s). This leakage current impacts the normalized charge-discharge curves (FIG. 13A) by creating a plateau at high voltages in the charge curve which is absent in the discharge curve. This asymmetry between charge and discharge curves is visible for PAAK but not for EMIES; and it is quantified as the ratio Q_{C}/Q_{D} between the integrated charge during charge Qc and discharge Q_{D} (FIG. 13b). Without leakage current the ratio is 1, but due to side reactions this ratio becomes larger than 1 with PAAK above 2.2 V, while it is close to 1 for up to 2.8 V with EMIES. Finally, the self-discharge is recorded starting from three different potentials (1 V, 2 V, 2.8 V) and plotted in FIG. 13c. It is surprising to see that for a device charged at 2 or 2.8 V, the rate of self-discharge is higher for the EMIES than PAAK in the critical range of hours and days. Regarding the mechanism of self-discharge in the AC/PAAK/AC supercapacitor, there is a correlation between the leakage current (deviation from Q_{C}/Q_{D} = 1 in FIG. 13B) increasing above 1 V and the shape of the self-discharge in FIG. 13C that displays a fast rate in the high potential region until it reaches about 1 V. At 1 V, the rate of self-discharge at early time is constant and the leakage is negligible with Q_{C}/Q_{D} = 1. Hence, this suggests that water electrolysis current although drastically reduced when going from “water:PAAK” weight ratio from 6:1 to 2:1 by suppressing the free water molecules (FIG. 12A) is still the origin of the leakage current in the device and the major origin of the self-discharge mechanism. Importantly, compared to the other supercapacitors based on carbon electrodes and aqueous electrolytes found in the literature, the present AC/PAAK/AC supercapacitor possesses excellent self-discharge behavior, thereby providing a safe, scalable electrical energy storage device.

### Self-Discharge of All Organic Pseudocapacitor

Next, the performance of the organic pseudocapacitor composed of Carbon-Desulfonated Lignin (DSL-C) and Carbon-Polyimide (PI-C) electrodes with other polyacrylate derivatives: (PMVEMAK, PAAMAK and PAAK 100) derived electrolytes was investigated. Among all water-in-polymer salt electrolytes investigated, PAAK displayed best performance in terms of specific capacity, specific energy, and cyclic stability but the device built with the PMVEMAK electrolyte showed slowest self-discharge (FIG. 11A). Interestingly, the most viscous electrolyte PMVEMAK (viscosity = 33000 mPa.s) led to a device with the lowest decay in potential (~56% in 5 days); while with the less viscous electrolyte PAAMAK (viscosity = 7 mPa·s), the device showed the fastest potential decay (~83% in 2 days). The self-discharge process displays different regimes of potential drop (namely regimes 1, 2 and 3) when plotted in log scale (FIG. 11B). This specific shape of the self-discharge, including a low rate in regime 1 between 1 V and 0.8 V followed by a fast rate below 0.8 V is visible for all the various PAAK derivatives, but it is not observed with the Active Carbon/PAAK/Active Carbon supercapacitor. This suggests that the origin of this behavior is due to the redox polymers (herein, lignin and/or PI). It is contemplated that the main self-discharge mechanism is the leakage current due to the water electrolysis.

### Performance of Polyacrylate Electrolytes with Other Counter Ions

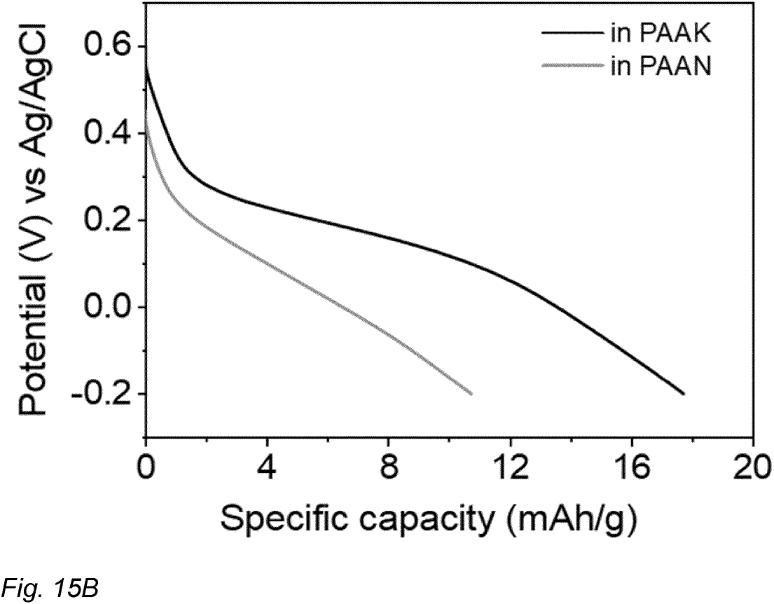

Electrochemical characterization of lignin based positive electrodes was done using different metal cations. Sodium and potassium are of especial interest and the selection of K+ ion based electrolyte over Na+ ion based systems is because solvated K+ ions possess smaller Stokes radii which helps to improve the ionic conductivity of electrolyte in comparison to Na+ ion-based electrolytes. Furthermore, initial electrochemical characterization also suggests enhanced performance of lignin based electrode materials in PAAK as presented in FIG. 15. The positive electrode shows 17.7 mAh g-1 of specific capacity in PAAK, however, it displays 10.7 mAh g-1 of specific capacity in sodium polyacrylate (PAANa) electrolyte at 1 A g-1 current.

### Electrochemical Performance of NiHCF in PAAK

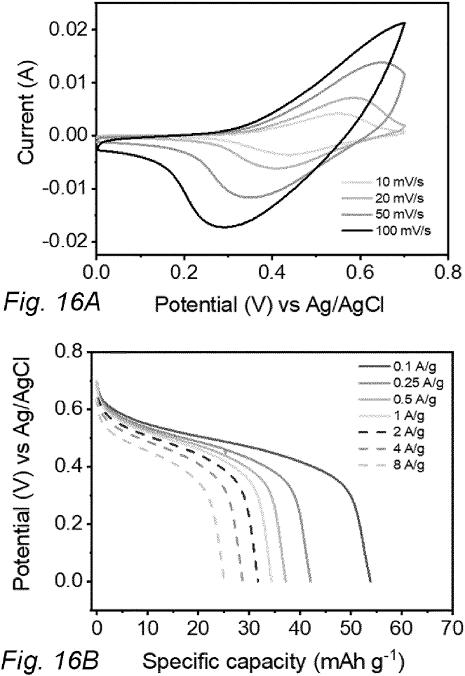

The electrode performance was examined in PAAK in a 3-electrode configuration, in which a NiHCF electrode was used as a positive electrode. The CV profile of the NiHCF electride displayed a well-defined pair of reversible redox peaks in PAAK (FIG. 16A). Galvanostatic charge discharge (GCD) was also performed to estimate the specific capacity of NiHCF in PAAK (FIG. 16B). The electrode showed maximum of 54 mAh g⁻¹ of specific capacity at 0.1 A g⁻¹ of current rate which decreases to 25 mAh g⁻¹ (55% of initial value) when current was increased 80 times more (8 A g⁻¹) suggesting excellent rate capability of NiHCF in PAAK.

### Electrochemical Performance of PACA-PEDOT in PAAK

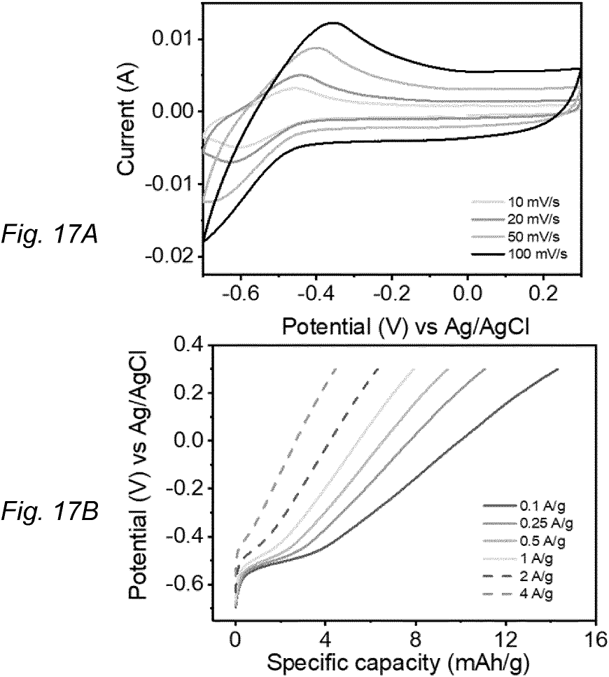

PACA-PEDOT electrodes was evaluated in a 3-electrode configuration in PAAK using the PACA-PEDOT electrode as a negative electrode. The CV profile displayed two kind of region one capacitive region associated with PEDOT and one reversible redox pair associated with PACA which was also observable at higher sweep rate indicating that kinetics related with capacitive and Faradaic processes are fast (FIG. 17A). Galvanostatic charge discharge (GCD) was performed to estimate the specific capacity. At 0.1 A g⁻¹ of current, PACA-PEDOT delivered 14.3 mAh g⁻¹ of specific capacity which reduced to 4.43 mAh g⁻¹ when current increased to 4 A g⁻¹ (FIG. 17B).

### Other Examples of Electrochemical Evaluation of Organic Electrode Materials in PAAK

Polyimides are attractive for energy storage applications due to their low cost and relatively easy preparation methods. Polyimides based on the pyromellitic scaffold are especially interesting due to commercial availability and a slightly more negative redox potential compared to the naphthalene type of polyimide used in PI-C, which could potentially increase cell voltage of the device. Test done using PAAK as electrolyte, as part of this invention, have so far only indicated 0 - 0.2 V difference in redox potential in PAAK between the naphthalene and pyromellitic type of polyimide. Capacity for pyromellitic polyimide is initially good, but suffer from poor cyclic stability.

Triazines is another class of interesting organic electrochemically redox active functional groups. The melamine based polyimide is an example of a triazine type of electrode materials. In a hypothetical example, cyclic voltammetry and galvanostatic charge discharge (GCD) was used to show that triazines are a suitable electrode material in the present invention.

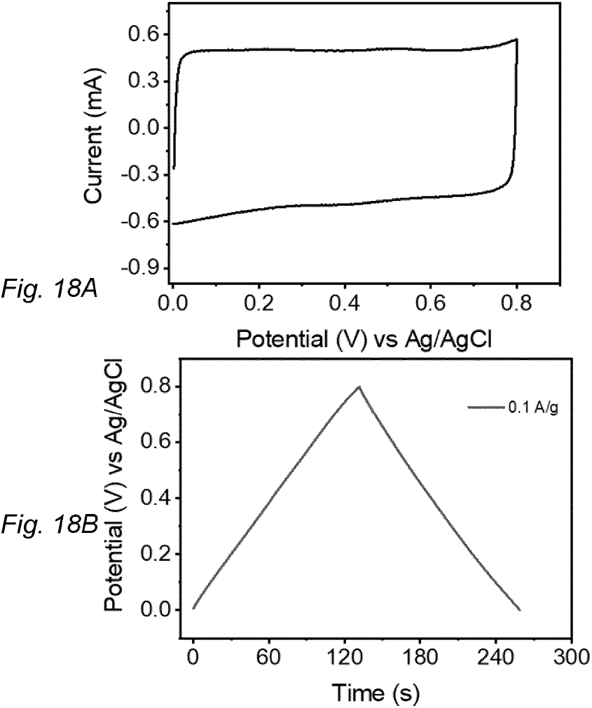

PEDOT:PSS is a well-studied polythiophene type electrode material combining good conductivity with some electric charge storage capability. PEDOT was used as additive mostly due to its electric conductivity in examples above and as part of the characterization work of PEDOT in PAAK the inventors have done an evaluation of PEDOT:PSS in a 3 electrode measurement. The CV in PAAK show a capacitive behavior and the specific capacity was measured using GPC to 3.5 mAh/g at 0.1 A/g (FIG. 18).

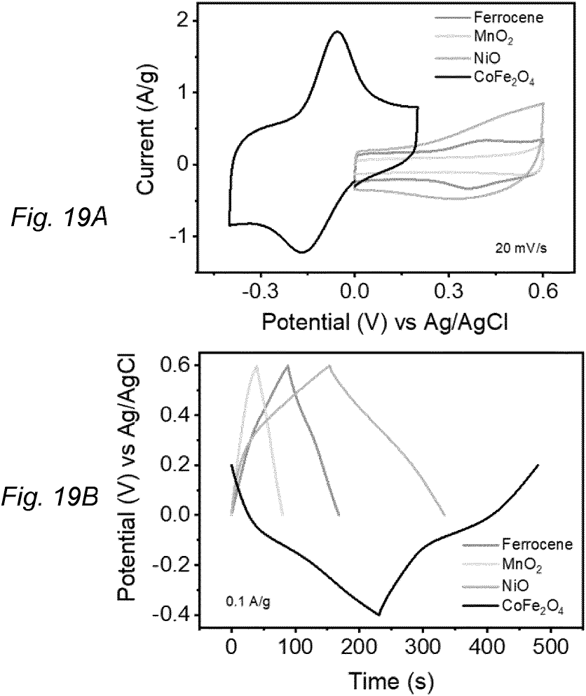

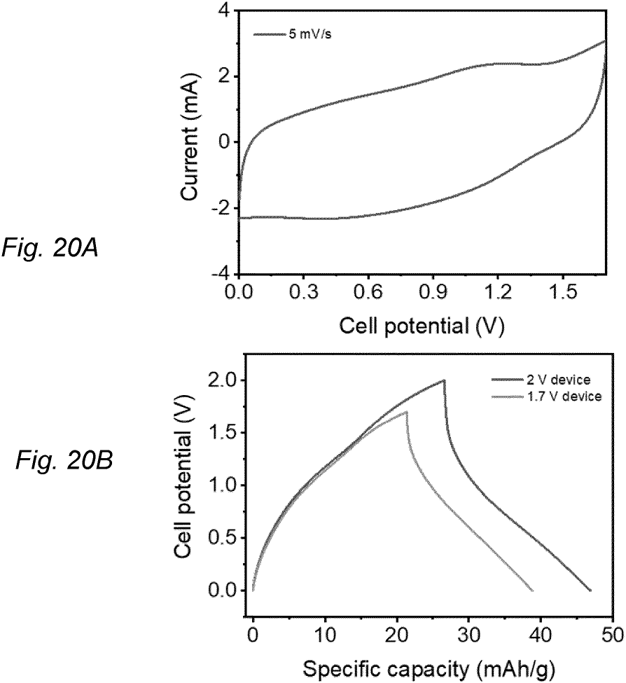

Organometallic compounds are chemical compounds containing at least one chemical bond between a carbon atom of an organic molecule and a metal. This is a separate class of organic materials that can be of particular interest for certain type of energy storage applications such as fuel cells. The solubility of the ferrocene complex can be modified by the addition of a solubilizing linker e.g. the commercially available N,N-dimethylferrocenylmethylamine, which hypothetically can be used to make the material more suitable for fuel cell applications. Electrical performance of ferrocene was tested in PAAK as an example of an organometallic electrode material. The CV profile of ferrocene show well defined reversible redox peak at 0.3-0.4 V relative Ag/AgCl and GCP showed a capacity of 2.2 mAh/g at 0.1 A/g (FIG. 19).

### Other Examples of Electrochemical Evaluation of Inorganic Metal Oxides Electrode Materials in PAAK

The performance of some common metal oxide compounds e.g. MnO₂, NiO, CoFe₂O₄ was evaluated in PAAK using CV and galvanostatic charge discharge (GCD) (FIG. 19). The NiO and CoFe₂O₄ show clear reversible redox peaks with specific capacity of 1.1, 5 and 7 mAh/g for MnO₂, NiO and CoFe₂O₄, respectively. The manganese oxide (MnO₂) is expected to be purely capacitive as observed in the CV. The capacity is overall rather poor and this might be a result of the electrode preparation method that has not been optimized for any of the materials evaluated in in FIG. 19.

### Hybrid Device

Another example is hybrids between supercapacitors and batteries i.e. a supercapacitor structure where one of the electrodes is replaced with a lignin-based electrode. This is an attractive configuration that can combine the attractive properties of supercapacitors and batteries, such as improved cycle performance, low self-discharge, and moderately high energy and power density. An example of a charge-discharge measurement of a lignin hybrid device is showed in FIG. 20. The non-linear discharge profile shows that energy storage involves Faradic reactions. The specific capacity for the hybrid device is recorded to 18 and 21 mAh/g using GPC when discharged up to 1.7 and 2 V, respectively.

### ITEMIZED LIST OF EMBODIMENTS

1. An energy storage device comprising a positive electrode, a negative electrode, and an aqueous polymer electrolyte disposed between the positive electrode and the negative electrode, wherein at least one of the electrodes is an organic electrode, and wherein the aqueous polymer electrolyte comprises:
   a metal ion component comprising a metal cation being Na⁺ or K⁺;
   a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof;
   wherein at least 20 mol-% of a total amount of monomers in the polymer is said carboxylic acid.
2. The energy storage device according to item 1, wherein the aqueous polymer electrolyte comprises
   a metal ion component comprising a metal cation being K⁺;
   the polymer component comprises poly(acrylic acid) (PAA), poly(methyl vinyl ether-alt-maleic acid) (PMVMA), poly(acrylic acid-co-maleic acid) (PAAMA) polymethacrylic acid (PMAA) poly(ethylene-co-acrylic acid), poly(N-isopropylacrylamide-co-methacrylic acid), sulfonated polyacrylic acid copolymer.
3. The energy storage device according to item 1 or 2, wherein both electrodes are organic electrodes.
4. The energy storage device according to any one of the preceding items, wherein the positive electrode comprises a polymer comprising redox active aromatic catechol groups, such as lignin.
5. The energy storage device according to item 4, wherein the positive electrode comprises lignosulfonate (LS) and/or Kraft lignin, preferably desulfonated lignosulfonate (DLS).
6. The energy storage device according to any one of the preceding items, wherein the negative electrode comprises polyimide.
7. The energy storage device according to any one of the preceding items, wherein the energy storage device is limited to cell voltages in the range of from 2.0 V to 0.9 V, such as in the range from 2.0 V.
8. The energy storage device according to any one of the preceding items, wherein the electrolyte has a pH in the range of 5.5-7.0.
9. The energy storage device according to item 8, wherein the aqueous polymer electrolyte comprises at least 20 wt-% of the polymer, of a total amount of electrolyte.
10. The energy storage device according to any of the preceding items, wherein the energy storage device is an all-organic battery comprising an organic positive electrode and an organic negative electrode, a supercapacitor, a pseudo-capacitor or a hybrid battery with one organic electrode and one supercapacitor electrode.
11. An aqueous polymer electrolyte comprising:
   a metal ion component comprising a metal cation selected from the group consisting of Na⁺, K⁺;
   a polymer or copolymer comprising at least one monomer unit selected from the list consisting of acrylic acid, methacrylic acid, maleic acid, vinyl acetate, vinyl alcohol, methyl vinyl ether, ethyl vinyl ether, N-isopropylacrylamide, vinyl difluoride, or mono-or di-substituted variants thereof; wherein the monomer units comprising carboxylic acid is at least 40 mol% of the total polymer.
12. The aqueous polymer electrolyte according to item 11, wherein
   the metal ion component comprises a metal cation being K⁺;
   the polymer component comprises poly(acrylic acid) (PAA), poly(methyl vinyl ether-alt-maleic acid) (PMVMA), poly(acrylic acid-co-maleic acid) (PAAMA) , polymethacrylic acid (PMAA) poly(ethylene-co-acrylic acid), poly(N-isopropylacrylamide-co-methacrylic acid), sulfonated polyacrylic acid copolymer; wherein said monomer unit is at least 20 mol-% of the total polymer.
13. A method for manufacturing an energy storage device comprising
   providing a positive electrode and a negative electrode;
   arranging an aqueous polymer electrolyte between the positive electrode and the negative electrode,
   wherein
   at least one of the positive electrode and the negative electrode is an organic electrode; and
   wherein the aqueous polymer electrolyte comprises
      metal ion component comprising a metal cation being Na⁺ or K⁺;
      a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof; wherein the monomer units comprising carboxylic acid is at least 20 mol% of the total polymer.
14. The method according to item 13, wherein the aqueous polymer electrode comprises
   a metal ion component comprising a metal cation being K⁺;
   the polymer component comprises poly(acrylic acid) (PAA), poly(methyl vinyl ether-alt-maleic acid) (PMVMA), poly(acrylic acid-co-maleic acid) (PAAMA) , polymethacrylic acid (PMAA), poly(ethylene-co-acrylic acid), poly(N-isopropylacrylamide-co-methacrylic acid), and/or sulfonated polyacrylic acid copolymer; wherein the monomer units comprising carboxylic acid is at least 20 mol% of the total polymer.
15. Use of an aqueous polymer electrolyte according to any one of items 11 or 12 in an energy storage device comprising at least one organic electrode.

1. An energy storage device comprising a positive electrode, a negative electrode, and an aqueous polymer electrolyte disposed between the positive electrode and the negative electrode, wherein at least one of the electrodes is an organic electrode comprising at least one organic redox active material, and wherein the aqueous polymer electrolyte comprises:
a metal ion component comprising a metal cation being Na⁺ or K⁺;
a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof;
wherein at least 20 mol-% of a total amount of monomers in the polymer is said carboxylic acid.

2. The energy storage device according to claim 1, wherein the aqueous polymer electrolyte comprises:
a metal ion component comprising a metal cation being K⁺;
the polymer component comprises poly(acrylic acid) (PAA), poly(methyl vinyl ether-alt-maleic acid) (PMVMA), poly(acrylic acid-co-maleic acid) (PAAMA) polymethacrylic acid (PMAA) poly(ethylene-co-acrylic acid), poly(N-isopropylacrylamide-co-methacrylic acid), sulfonated polyacrylic acid copolymer.

3. The energy storage device according to claim 1, wherein both electrodes are organic electrodes, each comprising at least one organic redox active material.

4. The energy storage device according to claim 1, wherein the positive electrode comprises a polymer comprising redox active catechol or quinone groups, such as lignin.

5. The energy storage device according to claim 4, wherein the positive electrode comprises lignosulfonate (LS), desulfonated lignosulfonate (DLS), organosolv lignin and/or Kraft lignin.

6. The energy storage device according to claim 1, wherein the positive electrode comprises a material selected from the list consisting of lignin, chemically modified lignin, polythiophene polymer, and metal hexacyanoferrate (mHCF).

7. The energy storage device according to claim 1, wherein the negative electrode comprises polyimide.

8. The energy storage device according to claim 1, wherein one electrode, preferably the negative electrode comprises at least 50%, by weight, of a carbon material, such as of activated carbon, graphite or hard carbon.

9. The energy storage device according to claim 1, wherein the negative electrode comprises a material selected from the list consisting of comprising polyimide, anthraquinone polymer, a redox active triazine based polymer, or a carbon material.

10. The energy storage device according to claim 1, wherein the energy storage device is limited to cell voltages in the range of from 2.5 V to 0.9 V.

11. The energy storage device according to claim 1, wherein the electrolyte has a pH in the range of 5.5-7.0.

12. The energy storage device according to claim 1, wherein the aqueous polymer electrolyte comprises at least 20 wt-% of the polymer, of a total amount of electrolyte.

13. The energy storage device according to claim 1, wherein the energy storage device is an all-organic battery comprising an organic positive electrode and an organic negative electrode, a supercapacitor, a pseudo-capacitor or a hybrid battery with one organic electrode and one supercapacitor electrode, wherein the organic electrodes each comprises at least one redox active organic material.

14. An aqueous polymer electrolyte comprising:
a metal ion component comprising a metal cation selected from the group consisting of Na⁺, K⁺;
a polymer or copolymer comprising at least one monomer unit selected from the list consisting of acrylic acid, methacrylic acid, maleic acid, vinyl acetate, vinyl alcohol, methyl vinyl ether, ethyl vinyl ether, N-isopropylacrylamide, vinyl difluoride, or mono-or di-substituted variants thereof; wherein the monomer units comprising carboxylic acid is at least 40 mol% of the total polymer.

15. The aqueous polymer electrolyte according to claim 13, wherein
the metal ion component comprises a metal cation being K⁺;
the polymer component comprises poly(acrylic acid) (PAA), poly(methyl vinyl ether-alt-maleic acid) (PMVMA), poly(acrylic acid-co-maleic acid) (PAAMA) , polymethacrylic acid (PMAA) poly(ethylene-co-acrylic acid), poly(N-isopropylacrylamide-co-methacrylic acid), sulfonated polyacrylic acid copolymer; wherein said monomer unit is at least 20 mol-% of the total polymer.

16. A method for manufacturing an energy storage device comprising:
providing a positive electrode and a negative electrode;
arranging an aqueous polymer electrolyte between the positive electrode and the negative electrode,
wherein
at least one of the positive electrode and the negative electrode is an organic electrode comprising at least one organic redox active material; and
wherein the aqueous polymer electrolyte comprises
metal ion component comprising a metal cation being Na⁺ or K⁺;
a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof; wherein the monomer units comprising carboxylic acid is at least 20 mol% of the total polymer.

17. The method according to claim 16, wherein the aqueous polymer electrode comprises:
a metal ion component comprising a metal cation being K⁺;
the polymer component comprises poly(acrylic acid) (PAA), poly(methyl vinyl ether-alt-maleic acid) (PMVMA), poly(acrylic acid-co-maleic acid) (PAAMA) , polymethacrylic acid (PMAA), poly(ethylene-co-acrylic acid), poly(N-isopropylacrylamide-co-methacrylic acid), and/or sulfonated polyacrylic acid copolymer; wherein the monomer units comprising carboxylic acid is at least 20 mol% of the total polymer.

18. Use of an aqueous polymer electrolyte according to claim 14 in an energy storage device comprising at least one organic electrode comprising at least one organic redox active material.

19. An energy storage device comprising: a positive electrode, a negative electrode, and an aqueous polymer electrolyte disposed between the positive electrode and the negative electrode;
a metal ion component comprising a metal cation being Na⁺ or K⁺;
a polymer or copolymer comprising at least one monomer unit being a carboxylic acid, such as an acrylic acid, methacrylic acid or maleic acid, and optionally at least one monomer unit selected from the list consisting of vinyl acetate, vinyl alcohol, methyl vinyl ether, ethyl vinyl ether, N-isopropylacrylamide, 2-acrylamido-2-methylpropanesulfonic acid, vinyl difluoride, or mono-or di-substituted variants thereof;
wherein at least 20 mol-% of a total amount of monomers in the polymer is said carboxylic acid.

20. Use of an aqueous polymer electrolyte according to claim 15 in an energy storage device comprising at least one organic electrode comprising at least one organic redox active material.
